(19) United States
(12) Patent Application Publication
(10) Pub. No.: US 2025/0097934 A1
(43) Pub. Date: Mar. 20, 2025

(54) TERMINAL APPARATUS, BASE STATION APPARATUS, AND COMMUNICATION METHOD

(71) Applicant: Sharp Kabushiki Kaisha, Sakai City, Osaka (JP)

(72) Inventors: Tomoki YOSHIMURA, Sakai City (JP); Toshizo NOGAMI, Sakai City (JP); Takahisa FUKUI, Sakai City (JP); Wataru OUCHI, Sakai City (JP); Shoichi SUZUKI, Sakai City (JP); Daiichiro NAKASHIMA, Sakai City (JP); Huifa LIN, Sakai City (JP); Ryota MORIMOTO, Sakai City (JP)

(21) Appl. No.: 18/723,957

(22) PCT Filed: Oct. 31, 2022
(86) PCT No.: PCT/JP2022/040679

§ 371 Date: Jun. 25, 2024

(30) Foreign Application Priority Data
Dec. 28, 2021 (JP) 2021-213828

(51) Int. Cl. H04W 72/1268

(52) U.S. Cl. CPC H04W 72/1268

(57) ABSTRACT

An apparatus includes a physical layer processing unit configured to transmit a PUSCH, and an RRC layer processing unit configured to provide the physical layer processing unit with a first RRC parameter for a first SS/PBCH block mapped to a first frequency position in a serving cell and a second RRC parameter for a second SS/PBCH block mapped to a second frequency position in the serving cell. The physical layer processing unit determines whether or not to drop transmission of the PUSCH, based on the first RRC parameter and the second RRC parameter.

### TECHNICAL FIELD

The present invention relates to a terminal apparatus, a base station apparatus, and a communication method.

This application claims priority to JP 2021-213828 filed on Dec. 28, 2021, the contents of which are incorporated herein by reference.

### BACKGROUND ART

In the 3^{rd} Generation Partnership Project (3GPP), a radio access method and a radio network for cellular mobile communications (hereinafter also referred to as “Long Term Evolution (LTE)” or “Evolved Universal Terrestrial Radio Access (EUTRA)”) have been studied. In LTE, a base station apparatus is also referred to as an evolved NodeB (eNodeB) and a terminal apparatus is also referred to as a User Equipment (UE). LTE is a cellular communication system in which multiple areas covered by base station apparatuses are arranged in a form of cells. A single base station apparatus may manage multiple serving cells.

In the 3GPP, a radio communication standard (New Radio, NR) formulation operation has been performed. The 3GPP has further been studying for extension of the radio communication standard (NPL 1).

### CITATION LIST

### Non Patent Literature

NPL 1: “Summary of RAN Re1-18 Workshop”, RWS-210659, RAN chair, 3GPP RAN Re1-18 workshop, 28th June-2nd Jul., 2021

### SUMMARY OF INVENTION

### Technical Problem

An aspect of the present invention provides a terminal apparatus and a base station apparatus that efficiently perform communication, and a communication method used for the terminal apparatus.

### Solution to Problem

(1) A first aspect of the present invention is a terminal apparatus including: a physical layer processing unit configured to transmit a PUSCH; and an RRC layer processing unit configured to provide the physical layer processing unit with a first RRC parameter for a first SS/PBCH block mapped to a first frequency position in a serving cell and a second RRC parameter for a second SS/PBCH block mapped to a second frequency position in the serving cell. The physical layer processing unit determines whether or not to drop transmission of the PUSCH, based on the first RRC parameter and the second RRC parameter.

(2) A second aspect of the present invention is a base station apparatus including: a physical layer processing unit configured to receive a PUSCH; and an RRC layer processing unit configured to provide the physical layer processing unit with a first RRC parameter for a first SS/PBCH block mapped to a first frequency position in a serving cell and a second RRC parameter for a second SS/PBCH block mapped to a second frequency position in the serving cell. The physical layer processing unit determines whether or not to drop reception of the PUSCH, based on the first RRC parameter and the second RRC parameter.

(3) A third aspect of the present invention is a communication method used for a terminal apparatus, the communication method including the steps of: transmitting a PUSCH; providing a physical layer with a first RRC parameter for a first SS/PBCH block mapped to a first frequency position in a serving cell and a second RRC parameter for a second SS/PBCH block mapped to a second frequency position in the serving cell; and determining whether or not to drop transmission of the PUSCH, based on the first RRC parameter and the second RRC parameter.

(4) A fourth aspect of the present invention is a communication method used for a base station apparatus, the communication method including the steps of: receiving a PUSCH; providing a physical layer with a first RRC parameter for a first SS/PBCH block mapped to a first frequency position in a serving cell and a second RRC parameter for the first SS/PBCH block mapped to a second frequency position in the serving cell; and determining whether or not to drop reception of the PUSCH, based on the second RRC parameter and the second RRC parameter.

### Advantageous Effects of Invention

According to an aspect of the present invention, the terminal apparatus can efficiently perform communication. The base station apparatus can efficiently perform communication.

### BRIEF DESCRIPTION OF DRAWINGS

FIG. 1 is a conceptual diagram of a radio communication system 9 according to an aspect of the present embodiment.

FIG. 2 is a diagram illustrating a configuration example of a resource grid according to an aspect of the present embodiment.

FIG. 3 is a schematic block diagram illustrating a configuration example of a base station apparatus 3 according to an aspect of the present embodiment.

FIG. 4 is a schematic block diagram illustrating a configuration example of a terminal apparatus 1 according to an aspect of the present embodiment.

FIG. 5 is a diagram illustrating an example of a procedure related to transmission of a PUSCH of the terminal apparatus 1 and the base station apparatus 3 according to an aspect of the present embodiment.

FIG. 6 is a diagram illustrating an example of a frame configuration of a cell 6000 in a TDD mode according to an aspect of the present embodiment.

FIG. 7 is a diagram illustrating a configuration example of SS/PBCH blocks of the cell 6000 according to an aspect of the present embodiment.

FIG. 8 is a diagram illustrating an example of transmission of uplink channels according to an aspect of the present embodiment.

FIG. 9 is a diagram illustrating an example of a configuration of a carrier according to an aspect of the present embodiment.

FIG. 10 is a diagram illustrating a configuration example of a maximum number N_{RB} of resource blocks of a transmission bandwidth configuration 9001 according to an aspect of the present embodiment.

FIG. 11 is a diagram illustrating a configuration example of a minimum value of a guard band 9003 that can be configured for a channel bandwidth 9000 according to an aspect of the present embodiment.

### DESCRIPTION OF EMBODIMENTS

An embodiment of the present invention will be described below. floor(C) may be a floor function for a real number C. For example, floor(C) may be a function that outputs a maximum integer in a range of not exceeding the real number C. ceil(D) may be a ceiling function for a real number D. For example, ceil(D) may be a function that outputs a minimum integer in a range of not falling below the real number D. mod(E, F) may be a function that outputs a remainder obtained by dividing E by F. mod(E, F) may be a function that outputs a value corresponding to the remainder obtained by dividing E by F. exp(G)=e\hat{ }G. Here, e is a Napier's constant. H\hat{ }I represents H to the power of I. max(J, K) is a function that outputs a maximum value out of J and K. Here, in a case that J and K are equal, max(J, K) is a function that outputs J or K. min(L, M) is a function that outputs a maximum value out of L and M. Here, in a case that L and M are equal, min(L, M) is a function that outputs L or M. round(N) is a function that outputs an integer value of a value closest to N. “*” represents multiplication.

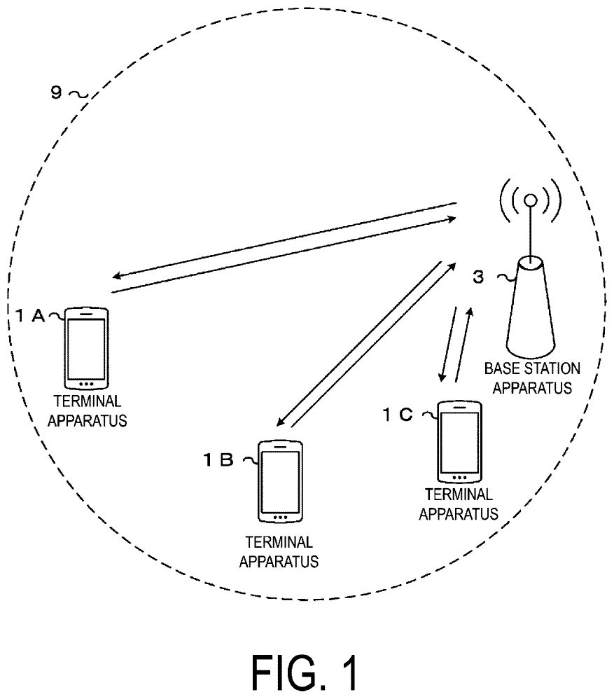

FIG. 1 is a conceptual diagram of a radio communication system 9 according to an aspect of the present embodiment. In FIG. 1, the radio communication system includes terminal apparatuses 1A to 1C and a base station apparatus 3 (Base station #3 (BS #3)). Hereinafter, as a general term for the terminal apparatuses 1A to 1C, the terminal apparatuses communicating with the base station apparatus 3 are also referred to as a terminal apparatus 1 (User Equipment #1 (UE #1)).

In the radio communication system 9, the terminal apparatus 1 and the base station apparatus 3 may use one or multiple communication schemes. For example, in a downlink of the radio communication system 9, Cyclic Prefix-Orthogonal Frequency Division Multiplex (CP-OFDM) may be used. In an uplink of the radio communication system 9, either CP-OFDM or Discrete Fourier Transform-spread-Orthogonal Frequency Division Multiplex (DFT-s-OFDM) may be used. Here, DFT-s-OFDM is a communication scheme in which Transform precoding is applied to CP-OFDM before signal generation. Here, Transform precoding is also referred to as DFT precoding.

As illustrated in FIG. 1, the base station apparatus 3 may include one transmission and/or reception apparatus (or transmission point, transmission apparatus, reception point, reception apparatus, transmission and/or reception point). On the other hand, in some cases, the base station apparatus 3 may include multiple transmission and/or reception apparatuses. In a case that the base station apparatus 3 includes multiple transmission and/or reception apparatuses, the multiple transmission and/or reception apparatuses may be arranged at geographically different positions.

The base station apparatus 3 may provide one or multiple serving cells. The serving cell may be defined as a set of resources used in the radio communication system 9. Here, the serving cell is also referred to as a cell.

The serving cell may include either or both of one downlink component carrier and one uplink component carrier. The serving cell may include either or both of two or more downlink component carriers, and/or two or more uplink component carriers. The downlink component carrier and the uplink component carrier are also generally referred to as a component carrier.

For a component carrier, one or multiple SCS-specific carriers (SCS-specificcarrier) may be configured. One subcarrier-spacing configuration p may be associated with one SCS-specific carrier.

The resources in the radio communication system 9 may be managed by a resource grid using subcarrier indices and OFDM symbol indices.

The SubCarrier Spacing (SCS) Δf for a certain subcarrier spacing configuration p may be Δf=2^{μ}*15 kHz. For example, the subcarrier spacing configuration p may indicate one of 0, 1, 2, 3, or 4.

The time unit T_{c}=1/(Δfₘₐₓ*N_{f}) may be used to represent the length of the time domain. Here Δfₘₐₓ may be 480 kHz. N_{f} may be 4096. A constant κ may be κ=Δfₘₐₓ*N_{f}/(Δf_{ref}*N_{f, ref})=64. Δf_{ref} may be 15 kHz. N_{f, ref} is 2048.

Transmission of a signal in the downlink/uplink may be organized into a radio frame (system frame, frame) having the length T_{f}. Here, T_{f} may be (Δfₘₐₓ*N/100)*Tₛ=10 ms.

The radio frame may include 10 subframes. Here, the length T_{sf} of the subframe may be (Δfₘₐₓ*N_{f}/1000)*Tₛ=1 ms. The number of OFDM symbols per subframe may be N^{subframe}, μ^{symb}=N^{slot}_{symb}*N^{subframe, μ}ₛₗₒₜ.

An OFDM symbol is used as a time domain unit of the communication scheme used in the radio communication system 9. For example, the OFDM symbol may be used as a time domain unit of CP-OFDM. The OFDM symbol may be used as a time domain unit of DFT-s-OFDM.

The slot may include multiple OFDM symbols. For example, N^{slot}_{symb} continuous OFDM symbols may constitute one slot. For example, in normal CP configuration, N^{slot}_{symb} may be 14. In extended CP configuration, N^{slot}_{symb} may be 12.

The slots may be indexed in the time domain. For example, slot indices n^{μ}ₛ may be given in ascending order in the subframe with integer values within a range of 0 to N^{subframe, μ}ₛₗₒₜ−1. Slot indices n^{μ}_{s, f} may be given in ascending order in the radio frame with integer values within a range of 0 to N^{frame, μ}ₛₗₒₜ−1.

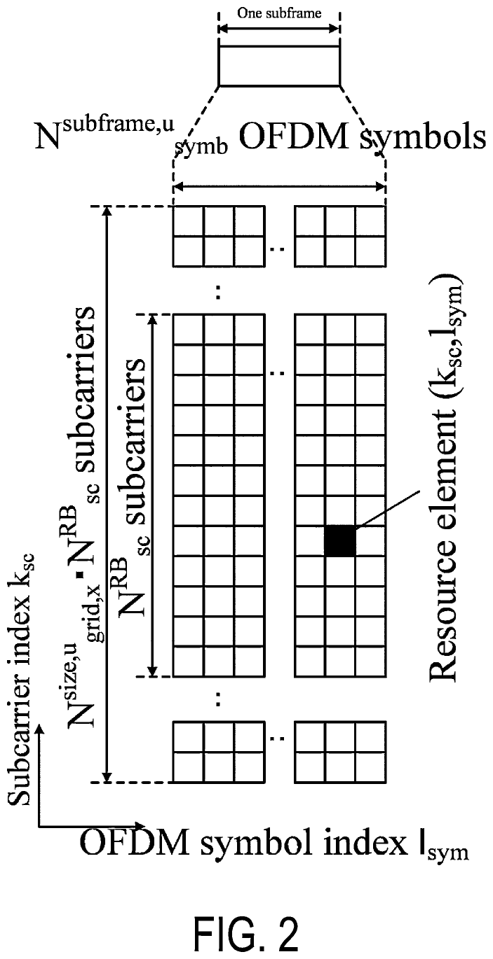

FIG. 2 is a diagram illustrating a configuration example of the resource grid according to an aspect of the present embodiment. In the resource grid of FIG. 2, the horizontal axis corresponds to an OFDM symbol index l_{sym}, and the vertical axis corresponds to a subcarrier index k_{sc}. The resource grid in FIG. 2 includes N^{size, μ}_{grid, x}*N^{RB}_{sc} subcarriers, and N^{subframe, μ}_{symb} OFDM symbols. Here, N^{size, μ}_{grid, x} denotes the bandwidth of the SCS-specific carrier. The unit of the value of N^{size, μ}_{grid, x} is a resource block.

In the resource grid, a resource identified by the subcarrier index k_{sc} and the OFDM symbol index l_{sym} is also referred to as a ResourceElement (RE)).

The Resource Block (RB) includes N^{RB}_{sc} contiguous subcarriers. The resource block is a general term for a common resource block, a Physical Resource Block (PRB), and a Virtual Resource Block (VRB). For example, N^{RB}_{sc} may be 12.

A BandWidth Part (BWP) may be configured as a subset of the resource grid. The BWP configured for the downlink is also referred to as a downlink BWP. The BWP configured for the uplink is also referred to as an uplink BWP.

An antenna port is defined such that the channel over which a symbol on the antenna port is conveyed can be inferred from the channel over which another symbol on the same antenna port is conveyed. For example, the channel may correspond to a physical channel. The symbol may correspond to a modulation symbol mapped to a resource element. Here, the “channel” may mean a “propagation path”. The “channel” may mean a “physical channel”.

In a case that a large scale property of a channel over which a symbol on one antenna port is conveyed can be inferred from a channel over which a symbol on another antenna port is conveyed, two antenna ports are considered to be in a Quasi Co-Located (QCL) relationship. Here, the large scale property may include long term performance of a channel. The large scale property may include a part or all of delay spread, Doppler spread, Doppler shift, an average gain, an average delay, and a beam parameter (spatial Rx parameters). The fact that the first antenna port and the second antenna port are QCL with respect to a beam parameter may mean that a reception beam assumed by a receiver side for the first antenna port and a reception beam assumed by the receiver side for the second antenna port are the same (or the reception beams correspond to each other). The fact that the first antenna port and the second antenna port are QCL with respect to a beam parameter may mean that a transmission beam assumed by a receiver side for the first antenna port and a transmission beam assumed by the receiver side for the second antenna port are the same (or the transmission beams correspond to each other). In a case that the large scale property of a channel over which a symbol on one antenna port is conveyed can be inferred from a channel over which a symbol on another antenna port is conveyed, the terminal apparatus 1 may assume that the two antenna ports are QCL. The fact that two antenna ports are QCL may mean that the two antenna ports are assumed to be QCL.

Carrier aggregation may mean that communication is performed by using multiple serving cells being aggregated. Carrier aggregation may mean that communication is performed by using multiple component carriers being aggregated. Carrier aggregation may mean that communication is performed by using multiple downlink component carriers being aggregated. Carrier aggregation may mean that communication is performed by using multiple uplink component carriers being aggregated.

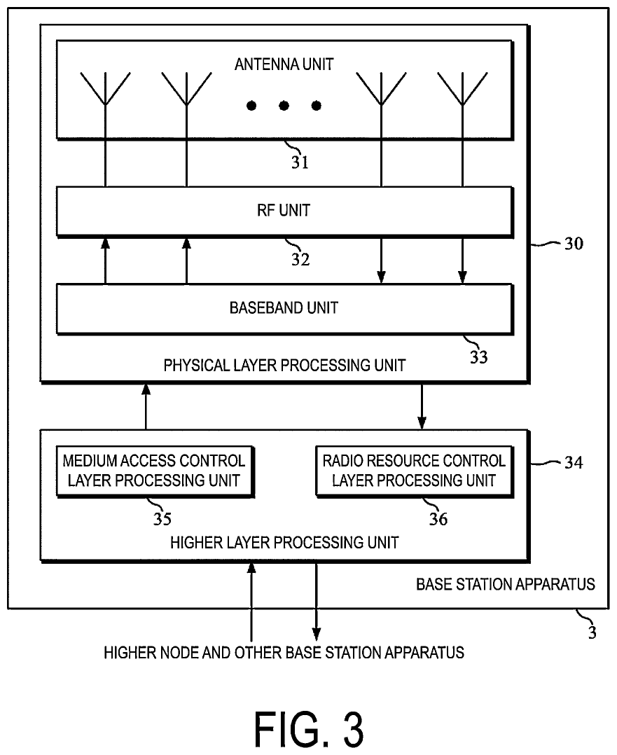

FIG. 3 is a schematic block diagram illustrating a configuration example of the base station apparatus 3 according to an aspect of the present embodiment. As illustrated in FIG. 3, the base station apparatus 3 includes a part or all of a physical layer processing unit (radio transmission and/or reception unit) 30 and/or a Higher layer processing unit 34. The physical layer processing unit 30 includes a part or all of an antenna unit 31, a Radio Frequency (RF) unit 32, and a baseband processing unit 33. The higher layer processing unit 34 includes a part or all of a medium access control layer (MAC layer) processing unit 35 and a Radio Resource Control (RRC) layer processing unit 36.

The physical layer processing unit 30 performs processing of the physical layer. Here, the processing of the physical layer may include some or all of generation of a baseband signal of a physical channel, generation of a baseband signal of a physical signal, detection of information conveyed by the physical channel, and detection of information conveyed by the physical signal. The processing of the physical layer may include processing of mapping a transport channel to the physical channel. Here, the baseband signal is also referred to as a time-continuous signal.

For example, the physical layer processing unit 30 may generate a baseband signal of the downlink physical channel. Here, a transport block delivered by a higher layer on the DL-SCH may be mapped to the downlink physical channel.

For example, the physical layer processing unit 30 may generate a baseband signal of the downlink physical signal.

For example, the physical layer processing unit 30 may attempt to detect information conveyed by the uplink physical channel. Here, a transport block included in the information conveyed by the uplink physical channel may be delivered to a higher layer on the UL-SCH.

For example, the physical layer processing unit 30 may attempt to detect information conveyed by the uplink physical signal.

The higher layer processing unit 34 performs some or all of processing operations of a Medium Access Control (MAC) layer, a Packet Data Convergence Protocol (PDCP) layer, a Radio Link Control (RLC) layer, and an RRC layer. Here, the MAC layer is also referred to as a MAC sublayer. The PDCP layer is also referred to as a PDCP sublayer. The RLC layer is also referred to as an RLC sublayer. The RRC layer is also referred to as an RRC sublayer.

The medium access control layer processing unit (MAC layer processing unit) 35 performs processing of the MAC layer. Here, the processing of the MAC layer may include a part or all of mapping between a logical channel and a transport channel, multiplexing one or multiple MAC Service Data Units (SDUs) on a transport block, decomposing a transport block delivered from the physical layer on the UL-SCH into one or multiple MAC SDUs, applying a Hybrid Automatic Repeat reQuest (HARQ) to the transport block, and processing a scheduling request.

The radio resource control layer processing unit 36 performs processing of the RRC layer. The processing of the RRC layer may include a part or all of management of a broadcast signal, management of an RRC connected/RRC idle state, and RRC reconfiguration.

The radio resource control layer processing unit 36 may manage RRC parameters used for various configurations of the terminal apparatus 1. For example, the radio resource control layer processing unit 36 may include the RRC parameter in an RRC message on a certain logical channel and transmit the RRC message to the terminal apparatus 1. Here, the RRC message may be mapped to any of a Broadcast Control CHannel (BCCH), a Common Control CHannel (CCCH), and a Dedicated Control CHannel (DCCH).

The radio resource control layer processing unit 36 may determine the RRC parameter to be transmitted to the terminal apparatus 1, based on the RRC parameter included in the RRC message transmitted from the terminal apparatus 1. Here, the RRC message transmitted from the terminal apparatus 1 may be related to a function information report of the terminal apparatus 1.

The physical layer processing unit 30 may perform a part or all of modulation processing, coding processing, and transmission processing. The physical layer processing unit 30 may generate a physical signal based on a part or all of coding processing, modulation processing, and baseband signal generation processing for a transport block. The physical layer processing unit 30 may map a physical signal to a certain BWP. The physical layer processing unit 30 may transmit a generated physical signal.

The physical layer processing unit 30 may perform one or both of demodulation processing and decoding processing. The physical layer processing unit 30 may deliver, to the higher layer on the UL-SCH, a transport block included in the information detected based on the demodulation processing and the decoding processing on a received physical signal.

In a case that carrier sense is requested to be performed in the band of the serving cell, the physical layer processing unit 30 may perform the carrier sense prior to the transmission of the physical signal.

The RF unit 32 may convert a signal received via the antenna unit 31 into a baseband signal (basebandsignal) to remove unnecessary frequency components from the signal. The RF unit 32 outputs the baseband signal to the baseband unit 33.

The baseband unit 33 may digitize the baseband signal received from the RF unit 32. The baseband unit 33 may remove a portion of the digitized baseband signal corresponding to a Cyclic Prefix (CP). The baseband unit 33 may perform a Fast Fourier Transform (FFT) on the baseband signal from which the CP has been removed to extract a signal in the frequency domain.

The baseband unit 33 may generate a baseband signal by performing Inverse Fast Fourier Transform (IFFT) on the physical signal. The baseband unit 33 may add the CP to the generated baseband signal. The baseband unit 33 may convert the baseband signal to which the CP is added into an analog signal. The baseband unit 33 may output the converted analog baseband signal to the RF unit 32.

The RF unit 32 may remove unnecessary frequency components from the baseband signal received from the baseband unit 33. The RF unit 32 may generate an RF signal by up converting the baseband signal to a carrier frequency. The RF unit 32 may transmit an RF signal via the antenna unit 31. The RF unit 32 may have a function of controlling transmit power.

For the terminal apparatus 1, one or multiple serving cells (or component carriers, downlink component carriers, uplink component carriers) may be configured.

Each of the serving cells configured for the terminal apparatus 1 may be one of a Primary cell (PCell), a Primary SCG cell (PSCell), or a Secondary Cell (SCell).

The PCell is a serving cell included in a Master Cell Group (MCG). The PCell is a cell in which an initial connection establishment procedure or a connection re-establishment procedure is performed (has been performed) by the terminal apparatus 1.

The PSCell is a serving cell included in a Secondary Cell Group (SCG). The PSCell is a serving cell in which a random access procedure is performed by the terminal apparatus 1.

The SCell may be included in either of the MCG or the SCG.

A serving cell group (cell group) is a general term for the MCG, SCG, and PUCCH cell group. The serving cell group may include one or multiple serving cells (or component carriers). One or multiple serving cells (or component carriers) included in the serving cell group may be operated by means of carrier aggregation.

One or multiple downlink BWPs may be configured for the terminal apparatus 1. One or multiple uplink BWPs may be configured for the terminal apparatus 1.

Among one or multiple downlink BWPs configured for the terminal apparatus 1, one downlink BWP may be configured as an active downlink BWP (or one downlink BWP may be activated). Among one or multiple uplink BWPs configured for the terminal apparatus 1, one uplink BWP may be configured as an active uplink BWP (or one uplink BWP may be activated).

The physical layer processing unit 30 may attempt to transmit the PDSCH, the PDCCH, and the CSI-RS on the active downlink BWP. A physical layer processing unit 10 may attempt to receive the PDSCH, the PDCCH, and the CSI-RS on the active downlink BWP. The physical layer processing unit 30 may attempt to receive the PUCCH and the PUSCH on the active uplink BWP. The physical layer processing unit 10 may attempt to transmit the PUCCH and the PUSCH on the active uplink BWP. Here, the active downlink BWP and the active uplink BWP are generally referred to as active BWPs.

The physical layer processing unit 30 need not attempt to transmit the PDSCH, the PDCCH, and the CSI-RS on an inactive downlink BWP (downlink BWP that is not the active downlink BWP). The physical layer processing unit 10 need not attempt to receive the PDSCH, the PDCCH, and the CSI-RS on the inactive downlink BWP. The physical layer processing unit 30 need not attempt to transmit the PUCCH and the PUSCH on an inactive uplink BWP (uplink BWP that is not the active uplink BWP). The physical layer processing unit 10 need not attempt to transmit the PUCCH and the PUSCH on the inactive uplink BWP. Here, the inactive downlink BWP and the inactive uplink BWP are generally referred to as inactive BWPs.

Downlink BWP switch is a procedure for deactivating one active downlink BWP of a certain serving cell and activating any one of the inactive downlink BWPs of the certain serving cell. The downlink BWP switch may be controlled by any one of the physical layer, the MAC layer, or the RRC layer.

Uplink BWP switch is used to deactivate one active uplink BWP of a certain serving cell and to activate any one of the inactive uplink BWPs of the certain serving cell. The uplink BWP switch may be controlled by any one of the physical layer, the MAC layer, or the RRC layer.

Among one or multiple downlink BWPs configured for the terminal apparatus 1, two or more downlink BWPs need not be configured as active downlink BWPs. For a certain component carrier, at certain time, one downlink BWP may be active.

Among one or multiple uplink BWPs configured for the terminal apparatus 1, two or more uplink BWPs need not be configured for the active uplink BWP. For a certain component carrier, at certain time, one uplink BWP may be active.

For each downlink component carrier, one downlink BWP may be configured as an active BWP. In other words, for a certain downlink component carrier, two or more downlink BWPs need not be configured as active downlink BWPs.

For each uplink component carrier, one uplink BWP may be configured as an active BWP. In other words, for a certain uplink component carrier, two or more uplink BWPs need not be configured as active uplink BWPs.

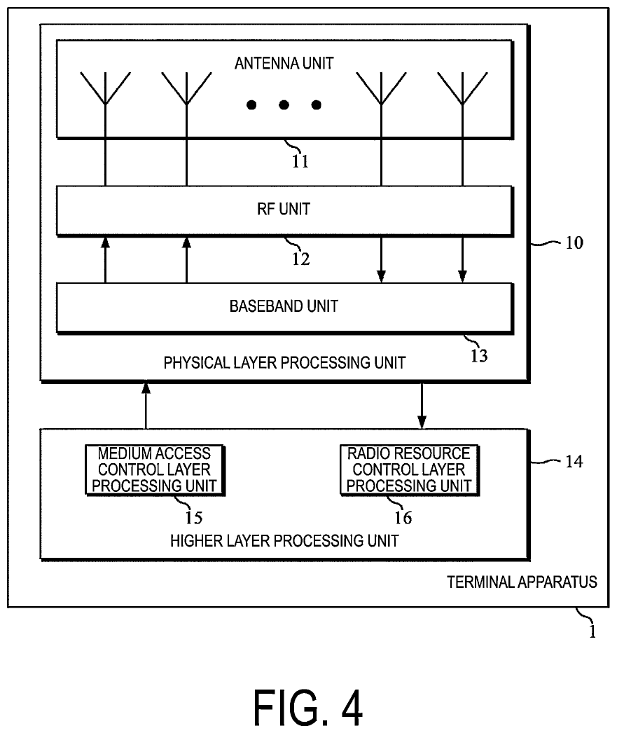

FIG. 4 is a schematic block diagram illustrating a configuration example of the terminal apparatus 1 according to an aspect of the present embodiment. As illustrated in FIG. 4, the terminal apparatus 1 includes a part or all of the physical layer processing unit (radio transmission and/or reception unit) 10 and a higher layer processing unit 14. The radio transmission and/or reception unit 10 includes a part or all of an antenna unit 11, an RF unit 12, and a baseband unit 13. The higher layer processing unit 14 includes at least a part or all of a medium access control layer processing unit 15 and a radio resource control layer processing unit 16.

The physical layer processing unit 10 performs processing of the physical layer.

For example, the physical layer processing unit 10 may generate a baseband signal of the uplink physical channel. Here, the transport block delivered by the higher layer on the UL-SCH may be mapped to the uplink physical channel.

For example, the physical layer processing unit 10 may generate a baseband signal of the uplink physical signal.

For example, the physical layer processing unit 10 may attempt to detect information conveyed by the downlink physical channel. Here, a transport block included in the information carried by the downlink physical channel may be delivered to the higher layer on the DL-SCH.

For example, the physical layer processing unit 10 may attempt to detect information conveyed by the downlink physical signal.

The higher layer processing unit 14 performs some or all of processing operations of a Medium Access Control (MAC) layer, a Packet Data Convergence Protocol (PDCP) layer, a Radio Link Control (RLC) layer, and an RRC layer.

The medium access control layer processing unit (MAC layer processing unit) 15 performs processing of the MAC layer.

The radio resource control layer processing unit 16 performs processing of the RRC layer.

The radio resource control layer processing unit 16 may manage the RRC parameter transmitted from the base station apparatus 3. For example, the radio resource control layer processing unit 16 may acquire the RRC parameter included in the RRC message on a certain logical channel and set the acquired RRC parameter in a storage area of the terminal apparatus 1. The RRC parameter set in the storage area of the terminal apparatus 1 may be provided to a lower layer.

The radio resource control layer processing unit 16 may include, in the RRC message, function information generated based on the function included in the terminal apparatus 1 and transmit the RRC message to the base station apparatus 3.

The physical layer processing unit 10 may perform a part or all of modulation processing, coding processing, and transmission processing. The physical layer processing unit 10 may generate a physical signal based on a part or all of coding processing, modulation processing, and baseband signal generation processing for a transport block. The physical layer processing unit 10 may map a physical signal to a certain BWP. The physical layer processing unit 10 may transmit the generated physical signal.

The physical layer processing unit 10 may perform one or both of demodulation processing and decoding processing. The physical layer processing unit 10 may deliver, to the higher layer on the DL-SCH, a transport block included in the information detected based on the demodulation processing and the decoding processing on the received physical signal.

In a case that carrier sense is requested to be performed in the band of the serving cell, the physical layer processing unit 10 may perform the carrier sense prior to the transmission of the physical signal.

The RF unit 12 may convert a signal received via the antenna unit 11 into a baseband signal (basebandsignal) to remove unnecessary frequency components from the signal. The RF unit 12 outputs the baseband signal to the baseband unit 13.

The baseband unit 13 may digitize the baseband signal received from the RF unit 12. The baseband unit 13 may remove a portion of the digitized baseband signal corresponding to a Cyclic Prefix (CP). The baseband unit 13 may perform Fast Fourier Transform (FFT) on the baseband signal from which the CP has been removed to extract a signal in the frequency domain.

The baseband unit 13 may generate a baseband signal by performing Inverse Fast Fourier Transform (IFFT) on the physical signal. The baseband unit 13 may add the CP to the generated baseband signal. The baseband unit 13 may convert the baseband signal to which the CP is added into an analog signal. The baseband unit 13 may output the converted analog baseband signal to the RF unit 12.

The RF unit 12 may remove unnecessary frequency components from the baseband signal received from the baseband unit 13. The RF unit 12 may generate an RF signal by up converting the baseband signal to the carrier frequency. The RF unit 12 may transmit an RF signal via the antenna unit 31. The RF unit 12 may have a function of controlling transmit power.

The physical signal will be described below.

The physical signal is a general term for a downlink physical channel, a downlink physical signal, an uplink physical channel, and an uplink physical channel. The physical channel is a general term for a downlink physical channel and an uplink physical channel. The physical signal is a general term for a downlink physical signal and an uplink physical signal.

The uplink physical channel may correspond to a set of resource elements for conveying information generated in a higher layer. The uplink physical channel may be a physical channel used in the uplink component carrier. The uplink physical channel may be transmitted by the physical layer processing unit 10. The uplink physical channel may be received by the physical layer processing unit 30. In the uplink of the radio communication system according to an aspect of the present embodiment, a part or all of the following uplink physical channels may be used.
Physical Uplink Control CHannel (PUCCH)
Physical Uplink Shared CHannel (PUSCH)
Physical Random Access CHannel (PRACH)

The PUCCH may be transmitted for conveying (delivering, transmitting) Uplink Control Information (UCI). The uplink control information may be mapped to the PUCCH. The physical layer processing unit 10 may transmit the PUCCH to which the uplink control information is mapped. The physical layer processing unit 30 may receive the PUCCH to which the uplink control information is mapped.

The uplink control information (uplink control information bit, uplink control information sequence, uplink control information type) includes a part or all of Channel State Information (CSI), a Scheduling Request (SR), and Hybrid Automatic Repeat request ACKnowledgement (HARQ-ACK) information.

The channel state information is also referred to as a channel state information bit or a channel state information sequence. The scheduling request is also referred to as a scheduling request bit or a scheduling request sequence. The HARQ-ACK information is also referred to as a HARQ-ACK information bit or a HARQ-ACK information sequence.

The HARQ-ACK information may include a HARQ-ACK bit corresponding to a Transport block (TB). A certain HARQ-ACK bit may indicate an acknowledgement (ACK) or a negative-acknowledgement (NACK) corresponding to the transport block. The ACK may indicate that decoding of the transport block has been decoded successfully. The NACK may indicate that decoding of the transport block has not been decoded successfully. The HARQ-ACK information may include one or multiple HARQ-ACK bits.

A HARQ-ACK for the transport block is referred to as a HARQ-ACK for the PDSCH. Here, the “HARQ-ACK for the PDSCH” indicates the HARQ-ACK for the transport block included in the PDSCH.

The scheduling request may be used for requesting resources of the UL-SCH for new transmission. The scheduling request bit may be used for indicating either of a positive SR or a negative SR. The scheduling request bit indicating the positive SR is also referred to as “the positive SR being conveyed”. The positive SR may indicate that the medium access control layer processing unit 15 requests resources of the UL-SCH for new transmission. The scheduling request bit indicating the negative SR is also referred to as “the negative SR being transmitted”. The negative SR may indicate that the medium access control layer processing unit 15 requests no resources of the UL-SCH for new transmission.

Channel state information may include a part or all of a Channel Quality Indicator (CQI), a Precoder Matrix Indicator (PMI), and a Rank Indicator (RI). The CQI is an indicator related to quality (for example, propagation strength) of a propagation path or quality of a physical channel, and the PMI is an indicator related to a precoder. The RI is an indicator related to a transmission rank (or the number of transmission layers).

The channel state information is an indicator related to a reception state of a physical signal (for example, CSI-RS) used for channel measurement. The channel state information may be determined by the terminal apparatus 1 based on the reception state assumed by the physical signal used for channel measurement. Channel measurement may include interference measurement.

The PUCCH may have a certain PUCCH format. Here, the PUCCH format may be the form of processing in the physical layer for the PUCCH. The PUCCH format may be the form of information conveyed by using the PUCCH.

The PUSCH may be transmitted for conveying one or both of the uplink control information and the transport block. The PUSCH may be used for conveying one or both of the uplink control information and the transport block. The terminal apparatus 1 may transmit the PUSCH to which one or both of the uplink control information and the transport block are mapped. The base station apparatus 3 may receive the PUSCH to which one or both of the uplink control information and the transport block are mapped.

The PRACH may be transmitted for conveying the index of a random access preamble. The terminal apparatus 1 may transmit the PRACH. The base station apparatus 3 may receive the PRACH. The terminal apparatus 1 may transmit the random access preamble on the PRACH. The base station apparatus 3 may receive the random access preamble on the PRACH.

The uplink physical signal may correspond to a set of resource elements. The uplink physical signal need not be used to convey information generated in a higher layer. Note that the uplink physical signal may be used to convey information generated in a physical layer. The uplink physical signal may be a physical signal used in the uplink component carrier. The physical layer processing unit 10 may transmit the uplink physical signal. The physical layer processing unit 30 may receive the uplink physical signal. In the uplink of the radio communication system according to an aspect of the present embodiment, a part or all of the following uplink physical signals may be used.
UpLink Demodulation Reference Signal (UL DMRS)
Sounding Reference Signal (SRS)
UpLink Phase Tracking Reference Signal (UL PTRS)

The UL DMRS is a general term for a DMRS for the PUSCH and a DMRS for the PUCCH.

A set of antenna ports of the DMRS for the PUSCH (DMRS related to the PUSCH, DMRS included in the PUSCH, DMRS corresponding to the PUSCH) may be given based on a set of antenna ports for the PUSCH. For example, the set of antenna ports of the DMRS for the PUSCH may be the same as a set of antenna ports of the PUSCH.

A propagation path of the PUSCH may be inferred from the DMRS for the PUSCH.

A set of antenna ports of the DMRS for the PUCCH (DMRS related to the PUCCH, DMRS included in the PUCCH, DMRS corresponding to the PUCCH) may be the same as a set of antenna ports of the PUCCH.

A propagation path of the PUCCH may be inferred from the DMRS for the PUCCH.

The downlink physical channel may correspond to a set of resource elements for conveying information generated in a higher layer. The downlink physical channel may be a physical channel used in a downlink component carrier. The physical layer processing unit 30 may transmit the downlink physical channel. The physical layer processing unit 10 may receive the downlink physical channel. In the downlink of the radio communication system according to an aspect of the present embodiment, a part or all of the following downlink physical channels may be used.
Physical Broadcast Channel (PBCH)
Physical Downlink Control Channel (PDCCH)
Physical Downlink Shared Channel (PDSCH)

The PBCH may be transmitted for conveying one or both of a Master Information Block (MIB) and physical layer control information. Here, the physical layer control information is information generated in the physical layer. The MIB is an RRC message delivered by the higher layer on a Broadcast Control CHannel (BCCH).

The PDCCH may be used for transmitting Downlink Control Information (DCI). The downlink control information may be mapped to the PDCCH. The terminal apparatus 1 may receive the PDCCH to which the downlink control information is mapped. The base station apparatus 3 may transmit the PDCCH to which the downlink control information is mapped.

The downlink control information may be transmitted with a DCI format. Note that the DCI format may also be interpreted to be in the format of downlink control information. The DCI format may be interpreted as a set of downlink control information set to a certain format of downlink control information.

The base station apparatus 3 may notify the terminal apparatus 1 of the downlink control information by using the PDCCH in the DCI format. The terminal apparatus 1 may monitor the PDCCH in order to acquire the downlink control information. Note that the DCI format and the downlink control information may be described as equivalent unless otherwise specified. For example, the base station apparatus 3 may include the downlink control information in the DCI format and transmit the DCI format to the terminal apparatus 1. The terminal apparatus 1 may control the physical layer processing unit 10 by using the downlink control information included in the detected DCI format.

A DCI format 0_0, a DCI format 0_1, a DCI format 1_0, and a DCI format 1_1 are DCI formats. An uplink DCI format is a general term for the DCI format 0_0 and the DCI format 0_1. A downlink DCI format is a general term for the DCI format 1_0 and the DCI format 1_1.

The DCI format 0_0 is used for scheduling of the PUSCH mapped to a certain cell. The DCI format 00 may include a part or all of fields listed from 1A to 1E.
1A) Identifier field for DCI formats
1B) Frequency domain resource assignment field
1C) Time domain resource assignment field
1D) Frequency hopping flag field
1E) Modulation and Coding Scheme (MCS) field

The identifier field for DCI formats may indicate whether the DCI format including the identifier field for DCI formats is an uplink DCI format or a downlink DCI format. In other words, each of the uplink DCI format and the downlink DCI format may include the identifier field for DCI formats. Here, the identifier field for DCI formats included in the DCI format 0_0 may indicate 0.

The frequency domain resource assignment field included in the DCI format 00 may be used for indicating assignment of frequency resources for the PUSCH scheduled by the DCI format 0_0.

The time domain resource assignment field included in the DCI format 0_0 may be used for indicating assignment of time resources for the PUSCH scheduled by the DCI format 0_0.

The frequency hopping flag field may be used to indicate whether frequency hopping is to be applied to the PUSCH scheduled by the DCI format 0_0.

An MCS field included in the DCI format 0_0 may be used for indicating one or both of a modulation scheme for the PUSCH scheduled by the DCI format 0_0 and a target coding rate scheduled by the DCI format 0_1. The target coding rate may be a target coding rate for the transport block mapped to the PUSCH. The Transport Block Size (TBS) of the PUSCH mapped to the PUSCH may be determined based on a part or all of the target coding rate and the modulation scheme for the PUSCH.

The DCI format 0_0 need not include a field used for a CSI request.

The DCI format 0_0 need not include a carrier indicator field. In other words, for the uplink component carrier to which the PUSCH scheduled by the DCI format 0_0 is mapped, the serving cell to which this uplink component carrier belongs may be the same as the serving cell of the downlink component carrier to which the PDCCH including the DCI format 0_0 is mapped. Based on detection of the DCI format 0_0 in a certain downlink component carrier of a certain serving cell, the terminal apparatus 1 may recognize that the PUSCH scheduled by the DCI format 0_0 is mapped to the uplink component carrier of the certain serving cell.

The DCI format 0_0 need not include the BWP field. Here, the DCI format 0_0 may be a DCI format for scheduling the PUSCH without changing the active uplink BWP. The terminal apparatus 1 may recognize that the PUSCH is transmitted without switching the active uplink BWP based on detection of the DCI format 0_0 used for the scheduling of the PUSCH.

The DCI format 0_1 is used for scheduling of the PUSCH mapped to a certain cell. The DCI format 0_1 includes a part or all of fields listed from 2A to 2H.
2A) Identifier field for DCI formats
2B) Frequency domain resource assignment field
2C) Uplink time domain resource assignment field
2D) Frequency hopping flag field
2E) MCS field
2F) CSI request field
2G) BWP field
2H) Carrier indicator field

The identifier field for DCI formats included in the DCI format 0_1 may indicate 0.

The frequency domain resource assignment field included in the DCI format 01 may be used for indicating assignment of frequency resources for the PUSCH scheduled by the DCI format 0_1.

The time domain resource assignment field included in the DCI format 0_1 may be used for indicating assignment of time resources for the PUSCH scheduled by the DCI format 0_1.

An MCS field included in the DCI format 0_1 may be used for indicating one or both of a modulation scheme for the PUSCH scheduled by the DCI format 0_1 and the target coding rate for the PUSCH scheduled by the DCI format 0_1.

The BWP field of the DCI format 01 may be used for indicating an uplink BWP to which the PUSCH scheduled by the DCI format 0_1 is mapped. In other words, the DCI format 01 may or may not be accompanied by a change in the active uplink BWP. The terminal apparatus 1 may recognize the uplink BWP to which the PUSCH is mapped based on detection of the DCI format 0_1 used for scheduling of the PUSCH.

The DCI format 0_1 not including the BWP field may be a DCI format for scheduling the PUSCH without changing the active uplink BWP. The terminal apparatus 1 may recognize that the PUSCH is transmitted without switching the active uplink BWP based on detection of the DCI format 0_1 which is the DCI format 0_1 used for the scheduling of the PUSCH and does not include the BWP field.

In a case that the BWP field is included in the DCI format 0_1 but the terminal apparatus 1 does not support the function of switching the BWP according to the DCI format 0_1, the terminal apparatus 1 may ignore the BWP field. In other words, the terminal apparatus 1 which does not support the function of switching the BWP may recognize that the PUSCH is transmitted without switching the active uplink BWP based on detection of the DCI format 0_1 which is the DCI format 0_1 used for the scheduling of the PUSCH and includes the BWP field. Here, in a case that the function of switching the BWP is supported, the radio resource control layer processing unit 16 may include, in the RRC message, function information indicating that the function of switching the BWP is supported.

The CSI request field may be used for indicating the report of the CSI.

In a case that the DCI format 0_1 includes the carrier indicator field, the carrier indicator field may be used for indicating the serving cell of the uplink component carrier to which the PUSCH is mapped. Based on detection of the DCI format 0_1 in the downlink component carrier of a certain serving cell, the terminal apparatus 1 may recognize that the PUSCH scheduled by the DCI format 0_1 is mapped to the uplink component carrier of the serving cell indicated by a carrier indicator field included in the DCI format 0_1.

In a case that the DCI format 0_1 does not include the carrier indicator field, then for the uplink component carrier to which the PUSCH scheduled by the DCI format 0_1 is mapped, the serving cell to which this uplink component carrier belongs may be the same as the serving cell of the downlink component carrier to which the PDCCH including the DCI format 0_1 is mapped. Based on detection of the DCI format 0_1 in a certain downlink component carrier of a certain serving cell, the terminal apparatus 1 may recognize that the PUSCH scheduled by the DCI format 0_1 is mapped to the uplink component carrier of the certain serving cell.

The DCI format 1_0 is used for scheduling of the PDSCH mapped to a certain cell. The DCI format 1_0 includes a part or all of 3A to 3F.
3A) Identifier field for DCI formats
3B) Frequency domain resource assignment field
3C) Time domain resource assignment field
3D) MCS field
3E) PDSCH_HARQ feedback timing indicator field (PDSCH to HARQ feedback timing indicator field)
3F) PUCCH resource indicator field

The identifier field for DCI formats included in the DCI format 1_0 may indicate 1.

The frequency domain resource assignment field included in the DCI format 10 may be used for indicating assignment of frequency resources for the PDSCH scheduled by the DCI format.

The time domain resource assignment field included in the DCI format 1_0 may be used for indicating assignment of time resources for the PDSCH scheduled by the DCI format.

The MCS field included in the DCI format 1_0 may be used for indicating one or both of the modulation scheme for the PDSCH scheduled by the DCI format and the target coding rate for the PDSCH scheduled by the DCI format. The target coding rate may be a target coding rate for the transport block mapped to the PDSCH. The Transport Block Size (TBS) of the PDSCH mapped to the PDSCH may be determined based on one or both of the target coding rate and the modulation scheme for the PDSCH.

The PDSCH_HARQ feedback timing indicator field may be used for indicating an offset from the slot including the last OFDM symbol of the PDSCH to the slot including the first OFDM symbol of the PUCCH.

The PUCCH resource indicator field may be used to indicate a resource of the PUCCH.

The DCI format 1_0 need not include the carrier indicator field. In other words, the downlink component carrier to which the PDSCH scheduled by using a DCI format 1_0 is mapped may be the same as the downlink component carrier to which the PDCCH including the DCI format 1_0 is mapped. Based on detection of the DCI format 1_0 in a certain downlink component carrier, the terminal apparatus 1 may recognize that the PDSCH scheduled by the DCI format 1_0 is mapped to the downlink component carrier.

The DCI format 1_0 need not include the BWP field. Here, DCI format 1_0 may be a DCI format for scheduling the PDSCH without changing the active downlink BWP. The terminal apparatus 1 may recognize that the PDSCH is received without switching the active downlink BWP based on detection of the DCI format 1_0 used in the scheduling of the PDSCH.

The DCI format 1_1 is used for scheduling of the PDSCH mapped to a certain cell. The DCI format 1_1 includes a part or all of 4A to 4I.
4A) Identifier field for DCI formats
4B) Frequency domain resource assignment field
4C) Time domain resource assignment field
4E) MCS field
4F) PDSCH_HARQ feedback timing indicator field
4G) PUCCH resource indicator field
4H) BWP field
4I) Carrier indicator field

The identifier field for DCI formats included in the DCI format 1_1 may indicate 1.

The frequency domain resource assignment field included in the DCI format 11 may be used for indicating assignment of frequency resources for the PDSCH scheduled by the DCI format 1_1.

The time domain resource assignment field included in the DCI format 1_1 may be used for indicating assignment of time resources for the PDSCH scheduled by the DCI format 1_1.

The MCS field included in the DCI format 1_1 may be used for indicating one or both of the modulation scheme for the PDSCH scheduled by the DCI format 1_1 and the target coding rate for the PDSCH scheduled by the DCI format 1_1.

In a case that the DCI format 1_1 includes the PDSCH_HARQ feedback timing indicator field, the PDSCH_HARQ feedback timing indicator field may be used for indicating an offset from the slot including the last OFDM symbol of the PDSCH to the slot including the first OFDM symbol of the PUCCH. In a case that the DCI format 1_1 does not include the PDSCH_HARQ feedback timing indicator field, a parameter indicating an offset from the slot including the last OFDM symbol of the PDSCH to the slot including the first OFDM symbol of the PUCCH may be provided by an RRC layer.

The PUCCH resource indicator field may be used to indicate a resource of the PUCCH.

The BWP field of the DCI format 11 may be used to indicate the downlink BWP to which the PDSCH scheduled by the DCI format 1_1 is mapped. In other words, the DCI format 11 may or may not be accompanied by a change in the active downlink BWP. The terminal apparatus 1 may recognize the downlink BWP to which the PDSCH is mapped based on detection of the DCI format 1_1 used for the scheduling of the PDSCH.

The DCI format 1_1 not including the BWP field may be a DCI format for scheduling the PDSCH without changing the active downlink BWP. The terminal apparatus 1 may recognize that the PDSCH is received without switching the active downlink BWP based on detection of the DCI format 1_1 which is used for the scheduling of the PDSCH and does not include the BWP field.

In a case that the DCI format 1_1 includes the BWP field but the terminal apparatus 1 does not support the function of switching the BWP according to the DCI format 1_1, the terminal apparatus 1 may ignore the BWP field. In other words, the terminal apparatus 1 which does not support the function of switching the BWP may recognize that the PDSCH is received without switching the active downlink BWP based on detection of the DCI format 1_1 which is used for the scheduling of the PDSCH and includes the BWP field. Here, in a case that the function of switching the BWP is supported, the radio resource control layer processing unit 16 may include, in the RRC message, function information indicating that the function of switching the BWP is supported.

In a case that the DCI format 1_1 includes the carrier indicator field, the carrier indicator field may be used for indicating the serving cell of the downlink component carrier to which the PDSCH scheduled by the DCI format 1_1 is mapped. Based on detection of the DCI format 1_1 in the downlink component carrier of a certain serving cell, the terminal apparatus 1 may recognize that the PDSCH scheduled by the DCI format 1_1 is mapped to the downlink component carrier of the serving cell indicated by the carrier indicator field included in the DCI format 1_1.

In a case that the DCI format 1_1 does not include the carrier indicator field, the downlink component carrier to which the PDSCH scheduled by the DCI format 1_1 is mapped may be the same as the downlink component carrier to which the PDCCH including the DCI format 1_1 is mapped. Based on detection of the DCI format 1_1 in a certain downlink component carrier, the terminal apparatus 1 may recognize that the PDSCH scheduled by the DCI format 1_1 is mapped to the downlink component carrier.

The PDSCH may be used for conveying the transport block. The PDSCH may be used for conveying the transport block. The transport block may be mapped to the PDSCH. The base station apparatus 3 may transmit the PDSCH to which the transport block is mapped. The terminal apparatus 1 may receive the PDSCH to which the transport block is mapped.

The downlink physical signal may correspond to a set of resource elements. The downlink physical signal need not be used to convey information generated in the higher layer. Note that the downlink physical signal may be used to convey information generated in the physical layer. The downlink physical signal may be a physical signal used in the downlink component carrier. The physical layer processing unit 10 may transmit the downlink physical signal. The physical layer processing unit 30 may receive the downlink physical signal. In the downlink of the radio communication system according to an aspect of the present embodiment, at least a part or all of the following downlink physical signals may be used.
Synchronization signal (SS)
DownLink DeModulation Reference Signal (DL DMRS)
Channel State Information-Reference Signal (CSI-RS)
DownLink Phase Tracking Reference Signal (DL PTRS)

The synchronization signal may be used for the terminal apparatus 1 to take synchronization in one or both of the frequency domain and the time domain in the downlink.

The synchronization signal is a general term for the Primary Synchronization Signal (PSS) and the Secondary Synchronization Signal (SSS).

The PSS, the SSS, the PBCH, and the antenna port of the DMRS for the PBCH may be the same.

The PBCH over which the symbol of the PBCH on a certain antenna port is conveyed may be inferred from the DMRS for the PBCH mapped to the slot to which the PBCH is mapped and for the PBCH included in the SS/PBCH block including the PBCH.

The DL DMRS is a general term for a DMRS for the PBCH, a DMRS for the PDSCH, and a DMRS for the PDCCH.

A set of antenna ports of the DMRS for the PDSCH (DMRS related to the PDSCH, DMRS included in the PDSCH, DMRS corresponding to the PDSCH) may be given based on a set of antenna ports for the PDSCH. For example, the set of antenna ports of the DMRS for the PDSCH may be the same as the set of antenna ports for the PDSCH.

A propagation path of the PDSCH may be inferred from the DMRS for the PDSCH. In a case that a set of resource elements in which the symbol of a certain PDSCH is conveyed and a set of resource elements in which the symbol of the DMRS for the certain PDSCH is conveyed are included in the same Precoding Resource Group (PRG), the PDSCH over which the symbol of the PDSCH on a certain antenna port is conveyed may be inferred from the DMRS for the PDSCH.

The antenna port of the DMRS for the PDCCH (DMRS related to the PDCCH, DMRS included in the PDCCH, DMRS corresponding to the PDCCH) may be the same as the antenna port for the PDCCH.

A propagation path of the PDCCH may be inferred from the DMRS for the PDCCH. In a case that the same precoder is (assumed to be) applied to a set of resource elements in which the symbol of a certain PDCCH is conveyed and a set of resource elements in which the symbol of the DMRS for the certain PDCCH is conveyed, the PDCCH over which the symbol of the PDCCH on a certain antenna port is conveyed may be inferred from the DMRS for the PDCCH.

A Broadcast CHannel (BCH), an Uplink-Shared CHannel (UL-SCH), and a Downlink-Shared CHannel (DL-SCH) are transport channels.

The BCH of the transport layer may be mapped to the PBCH of the physical layer. In other words, a transport block delivered by the higher layer on the BCH of the transport layer may be mapped to the PBCH of the physical layer. The UL-SCH of the transport layer may be mapped to the PUSCH of the physical layer. In other words, a transport block delivered by the higher layer on the UL-SCH of the transport layer may be mapped to the PUSCH of the physical layer. The DL-SCH of the transport layer may be mapped to the PDSCH of the physical layer. In other words, a transport block delivered by the higher layer on the DL-SCH of the transport layer may be mapped to the PDSCH of the physical layer.

The transport layer may apply the Hybrid Automatic Repeat reQuest (HARQ) to the transport block.

A Broadcast Control CHannel (BCCH), a Common Control CHannel (CCCH), and a Dedicated Control CHannel (DCCH) are logical channels. For example, the BCCH may be used for delivery of an RRC message including an MIB or an RRC message including system information. The CCCH may be used for transmitting an RRC message including an RRC parameter that is common to multiple terminal apparatuses 1. Here, the CCCH may be, for example, used for the terminal apparatus 1 that is not in a state of RRC connection. The DCCH may be used for transmitting an RRC message dedicated to a certain terminal apparatus 1. Here, the DCCH may be, for example, used for the terminal apparatus 1 that is in a state of RRC connection.

The RRC parameter common to the multiple terminal apparatuses 1 is also referred to as a common RRC parameter. Here, the common RRC parameter may be defined as a parameter specific to the serving cell. Here, the parameter specific to the serving cell may be a parameter common to terminal apparatuses configured with the serving cell (for example, the terminal apparatuses 1-A, 1-B, and 1-C).

For example, an RRC message delivered to the BCCH may include the common RRC parameter. For example, an RRC message delivered to the DCCH may include the common RRC parameter.

Among certain RRC parameters, an RRC parameter different from the common RRC parameter is also referred to as a dedicated RRC parameter. Here, the dedicated RRC parameter can provide a dedicated RRC parameter to the terminal apparatus 1-A configured with the serving cell. In other words, the dedicated RRC parameter is an RRC parameter capable of providing a unique configuration to each of the terminal apparatuses 1-A, 1-B, and 1-C.

The BCCH may be mapped to the BCH or the DL-SCH. In other words, the RRC message including the information of the MIB may be delivered to the BCH. The RRC message including the system information other than the MIB may be delivered to the DL-SCH. The CCCH is mapped to the DL-SCH or the UL-SCH. In other words, the RRC message mapped to the CCCH may be delivered to the DL-SCH or the UL-SCH. The DCCH may be mapped to the DL-SCH or the UL-SCH. In other words, the RRC message mapped to the DCCH may be delivered to the DL-SCH or the UL-SCH.

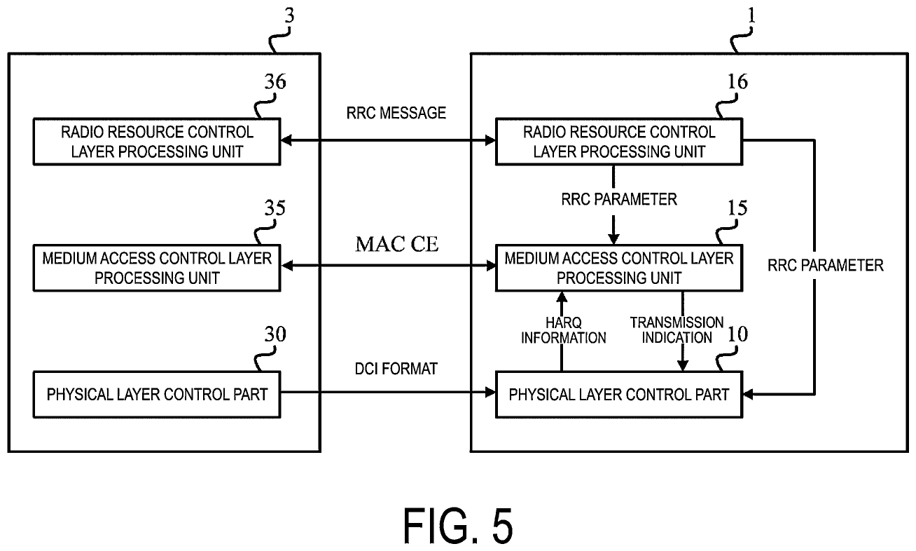

FIG. 5 is a diagram illustrating an example of a procedure related to PUSCH transmission between the terminal apparatus 1 and the base station apparatus 3 according to an aspect of the present embodiment. As illustrated in FIG. 5, the radio resource control layer processing unit 36 and the radio resource control layer processing unit 16 exchange RRC messages. The medium access control layer processing unit 35 and the medium access control layer processing unit 15 exchange MAC CEs. The physical layer processing unit 30 notifies the physical layer processing unit 10 of the DCI format.

The physical layer processing unit 10 interprets the received DCI format and delivers, to the medium access control layer processing unit 15, a part of information obtained based on the interpretation. Here, a part of the information obtained based on the interpretation is also referred to as HARQ information. For example, the HARQ information may include at least one or both of a HARQ Process Index (HPN) and a New Data Indicator (NDI). Here, in a case that the received DCI format schedules transmission of the PUSCH, the DCI format corresponds to an uplink grant.

In some cases, the DCI format may be replaced with a random access response grant. For example, the random access response grant may be used in scheduling the new transmission of a message 3 PUSCH in the random access procedure. Here, a PUSCH scheduled by the random access response grant in a 4-step contention-based random-access procedure is classified as the message 3 PUSCH. A PUSCH scheduled by a DCI format with a CRC sequence scrambled by a TC-RNTI in the 4-step contention-based random access procedure is classified as the message 3 PUSCH. A PUSCH scheduled by the random access response grant in a Contention-free random-access procedure is not classified as the message 3 PUSCH.

Here, a PUSCH scheduled by a fallback random access response grant in a two step contention-based random access procedure is classified as a fallback message 3 PUSCH. A PUSCH scheduled by the DCI format with the CRC sequence scrambled by the TC-RNTI in the two step contention-based random access procedure is classified as the fallback message 3 PUSCH.

Then, the medium access control layer processing unit 15 provides a transmission indication to the physical layer processing unit 10 based on the uplink grant. Here, for the transmission indication, the medium access control layer processing unit 15 may further refer to the RRC parameter provided by the radio resource control layer processing unit 16.

Then, the physical layer processing unit 10 transmits the PUSCH, based on the transmission indication provided by the medium access control layer processing unit 15. Here, in order to transmit the PUSCH, the physical layer processing unit 10 may further refer to an RRC parameter provided by the radio resource control layer processing unit 16.

Here, the RRC parameter provided by the radio resource control layer processing unit 16 to the medium access control layer processing unit 15 or the physical layer processing unit 10 may be a parameter managed by the radio resource control layer processing unit 16, based on an RRC message transmitted from the radio resource control layer processing unit 36.

Here, the radio resource control layer processing unit 36 may include, in the RRC message, an RRC parameter for determining a method of determining a transmission occasion for the PUSCH and transmit the RRC parameter to the radio resource control layer processing unit 16.

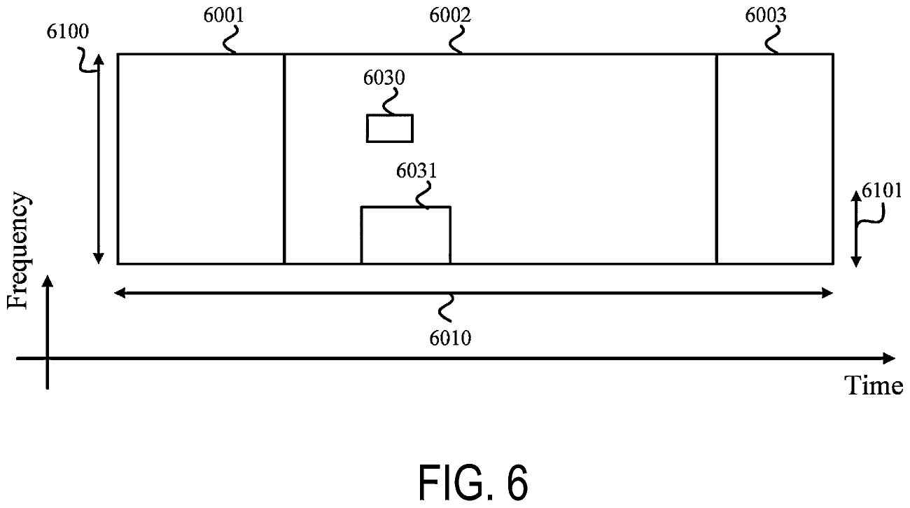

FIG. 6 is a diagram illustrating an example of a frame configuration of a cell 6000 in a TDD mode according to an aspect of the present embodiment. In FIG. 6, the horizontal axis indicates the time domain, and the vertical axis indicates the frequency domain. Here, 6001 represents a frequency band of the BWP configured for the cell 6000. Here, a BWP 6100 indicates a pair including a downlink BWP 6100a and an uplink BWP 6100b. In other words, in FIG. 6, a frequency bandwidth of the downlink BWP 6100a and a frequency bandwidth of the uplink BWP 6100b are the same, and a frequency position of the downlink BWP 6100a and a frequency position of the uplink BWP 6100b are the same. In this manner, with respect to a first frequency band and a second frequency band, “a frequency bandwidth of the first frequency band and a frequency bandwidth of the second frequency band are the same and a frequency position of the first frequency band and a frequency position of the second frequency band are the same” is also expressed as “the first frequency band and the second frequency band are the same”. In other words, in FIG. 6, the frequency band of the downlink BWP 6100a is the same as the frequency band of the uplink BWP 6100b.

“The frequency position of the first band and the second frequency position are the same” signifies that “the frequency position at the start of the first frequency band and the frequency position at the start of the second frequency band are the same and the frequency position at the end of the first frequency band and the frequency position at the end of the second frequency band are the same”.

In FIG. 6, 6001 represents a downlink region.

In FIG. 6, 6002 represents a flexible region.

In FIG. 6, 6003 represents an uplink region.

A pattern including the downlink region 6001, the flexible region 6002, and the uplink region 6003 is referred to as a TDD pattern. The TDD pattern is a pattern used in the serving cell in the TDD mode. 6010 represents a period of the TDD pattern.

6101 is a BWP configured for the terminal apparatus 1 of a first type. Here, the BWP 6100 may be recognized by the terminal apparatus 1 of the first type and the terminal apparatus 1 of a second type.

For example, in a certain frequency band, the terminal apparatus 1 of the first type is configured with a lower requirement of the number of antennas to be implemented than the terminal apparatus 1 of the second type. For example, in a certain frequency band, the requirement of the number of antennas to be implemented may be two antennas for the terminal apparatus 1 of the first type, and the requirement of the number of antennas to be implemented may be four antennas for the terminal apparatus 1 of the second type.

For example, in a certain frequency band, the frequency bandwidth to be supported by the terminal apparatus 1 of the first type may be a first set, and a second set of the frequency bandwidth to be supported by the terminal apparatus 1 of the second type may be a subset of the first set. For example, in a certain frequency band, the first set of the frequency bandwidth to be supported by the terminal apparatus 1 of the first type may be 5 MHz, 20 MHz, 40 MHz, and 100 MHz, and the second set of the frequency bandwidth to be supported by the terminal apparatus 1 of the second type may be 5 MHz and 20 MHz.

For example, in a certain frequency band, a maximum value of the frequency bandwidth to be supported by the terminal apparatus 1 of the first type may be smaller than a maximum value of the frequency bandwidth to be supported by the terminal apparatus 1 of the second type.

For example, in a certain frequency band, the maximum value of the frequency bandwidth to be supported by the terminal apparatus 1 of the first type may be 20 MHz, and the maximum value of the frequency bandwidth to be supported by the terminal apparatus 1 of the second type may be 100 MHz.

In this manner, the terminal apparatuses 1 of different types may coexist in the serving cell. For example, each of the terminal apparatus 1A and the terminal apparatus 1B may be the terminal apparatus 1 of the first type, and the terminal apparatus 1C may be the terminal apparatus 1 of the second type.

For example, in the random access procedure, the terminal apparatus 1 may report the type to which the terminal apparatus 1 confidence belongs to the base station apparatus 3. For example, the terminal apparatus 1 may report the type to which the terminal apparatus 1 confidence belongs via transmission of the PRACH. For example, the terminal apparatus 1 may determine resources of the PRACH to be transmitted, depending on the type to which the terminal apparatus 1 confidence belongs. The base station apparatus 3 may determine the type to which the terminal apparatus 1 that has transmitted the PRACH belongs, depending on the resources for detecting the PRACH.

For example, the terminal apparatus 1 may report the type to which the terminal apparatus 1 confidence belongs via transmission of message 3. For example, the terminal apparatus 1 may set values of bits included in message 3, depending on the type to which the terminal apparatus 1 confidence belongs.

As an example of the random access procedure of the terminal apparatus 1 in the cell 6000, Procedure 1 to Procedure 3 will be described.

Procedure 1: The terminal apparatus 1 of the first type attempts to detect a Cell-defining SS/PBCH block in the cell 6000.

In Procedure 1, the cell-defining SS/PBCH block may have a function of providing resources to be used for monitoring of the PDCCH including scheduling information of SIB1 out of system information left in the cell 6000. Here, the resources to be used for monitoring of the PDCCH including the scheduling information of SIB1 may be provided by a combination of a control resource set of index 0 and a search space set of index 0. Alternatively, the resources to be used for monitoring of the PDCCH including the scheduling information of SIB1 may be the search space set of index 0.

Procedure 2: After Procedure 1, the terminal apparatus 1 of the first type attempts to acquire SIB1. Here, SIB1 may include information related to the frequency band of the BWP 6100 and information related to the frequency band of the BWP 6101.

Procedure 3: The terminal apparatus 1 of the first type determines which of the BWPs is to be referred to for configuration in the terminal apparatus 1.

For example, the terminal apparatus 1 of the first type may determine which of the BWPs is to be referred to for the configuration in the terminal apparatus 1, based on whether or not to support the frequency bandwidth of the BWP 6100. For example, in a case that the terminal apparatus 1 of the first type supports the frequency bandwidth of the BWP 6100, the BWP 6100 may be referred to for the configuration in the terminal apparatus 1. In a case that the terminal apparatus 1 of the first type does not support the frequency bandwidth of the BWP 6100, the BWP 6101 may be referred to for the configuration in the terminal apparatus 1.

On the other hand, the terminal apparatus 1 of the second type may consider that connection to the cell 6000 is prohibited, based on whether or not to support the frequency bandwidth of the BWP 6100. For example, in a case that the terminal apparatus 1 of the second type supports the frequency bandwidth of the BWP 6100, the BWP 6100 may be referred to for the configuration in the terminal apparatus 1. In a case that the terminal apparatus 1 of the second type does not support the frequency bandwidth of the BWP 6100, the terminal apparatus 1 may consider that connection to the cell 6000 is prohibited.

Here, “a certain BWP is referred to for the configuration in the terminal apparatus 1” may signify that “a part or all of the configurations of the antenna unit 11, the RF unit 12, and the baseband unit 13 in the terminal apparatus 1 are applied based on the frequency bandwidth of the certain BWP”. For example, “the configuration of the antenna unit 11 in the terminal apparatus 1 is applied based on the frequency bandwidth of a certain BWP” may signify that “the antenna unit 11 is configured to be capable of receiving a signal in the frequency bandwidth of the certain BWP”. For example, “the configuration of the RF unit 12 in the terminal apparatus 1 is applied based on the frequency bandwidth of a certain BWP” may signify that “the RF unit 12 is configured to be capable of receiving a signal in the frequency bandwidth of the certain BWP”.

For example, “the configuration of the baseband unit 13 in the terminal apparatus 1 is applied based on the frequency bandwidth of a certain BWP” may signify that “the baseband unit 13 is configured to be capable of receiving a signal in the frequency bandwidth of the certain BWP”.

After Procedure 3, the terminal apparatus 1 refers to an RRC parameter related to the BWP selected in Procedure 3, and transmits and/or receives a channel. Here, in a case that the cell-defining SS/PBCH block is mapped outside of the frequency band of the BWP 6101, the terminal apparatus 1 that has selected the BWP 6101 in Procedure 3 cannot transmit the cell-defining SS/PBCH block.

Here, a Non-Cell defining SS/PBCH block may be introduced in the cell 6000. The non-cell defining SS/PBCH block may be included in the frequency band of the BWP 6101.

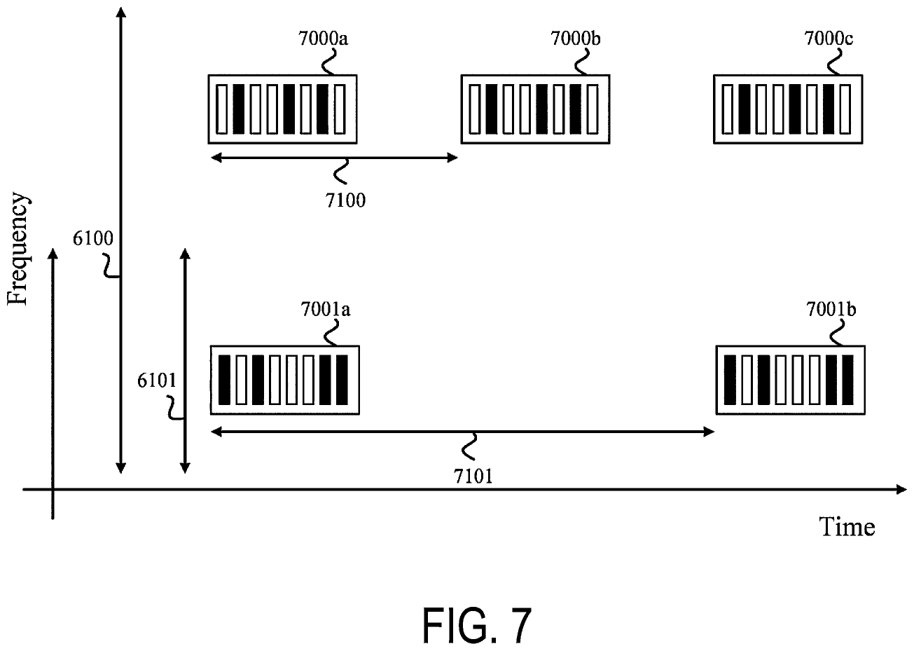

FIG. 7 is a diagram illustrating a configuration example of SS/PBCH blocks of the cell 6000 according to an aspect of the present embodiment. In FIG. 7, the horizontal axis indicates the time domain, and the vertical axis indicates the frequency domain. 7000 represents a set of SS/PBCH blocks. Here, the set 7000 is a general term for a set 7000a, a set 7000b, and a set 7000c. 7100 represents a transmission period of the set 7000. For example, 7100 may be 5 ms or 20 ms. For example, a value of the transmission period 7100 may be provided by an RRC parameter. For example, the value of the transmission period 7100 may be provided by an RRC parameter related to the BWP 6100. For example, the value of the transmission period 7100 may be provided by an RRC parameter used for configuration of the BWP 6100.

In FIG. 7, 7001 represents a set of SS/PBCH blocks. Here, the set 7001 is a general term for a set 7001a and a set 7001b. 7101 represents a transmission period of the set 7001. For example, 7101 may be 20 ms, 40 ms, 80 ms, or 160 ms. In this manner, a value of the transmission period 7101 may be larger than the value of the transmission period 7100. Alternatively, the value of the transmission period 7101 may be equal to the value of the transmission period 7100. For example, the value of the transmission period 7101 may be provided by an RRC parameter different from the RRC parameter used for provision of the value of the transmission period 7100. For example, the value of the transmission period 7101 may be provided by an RRC parameter related to the BWP 6101. For example, the value of the transmission period 7101 may be provided by an RRC parameter used for configuration of the BWP 6101.

The set 7000 includes eight SS/PBCH block candidates. Here, the eight SS/PBCH block candidates are respectively assigned candidate indexes of 0 to 7 in ascending order on the time axis. Here, the SS/PBCH block candidates may correspond to time frequency resources used for transmission of the SS/PBCH blocks. For example, an SS/PBCH block of index n may be transmitted in a resource corresponding to an SS/PBCH block candidate of index n. For example, an SS/PBCH block of index mod(n, Q) may be transmitted in a resource corresponding to the SS/PBCH block candidate of index n. Here, Q is a value provided by an RRC parameter.

Note that, in the following, for the sake of simplicity of description, it is assumed that the SS/PBCH block of index n is transmitted in the resource corresponding to the SS/PBCH block candidate of index n.

Here, first information may be provided for the set 7000. For example, the first information may provide a set of indexes of the SS/PBCH blocks to be transmitted in the set 7000. In FIG. 7, the first information indicates index 1, index 4, and index 6. In FIG. 7, the first information indicates that the SS/PBCH blocks are transmitted in resources corresponding to the SS/PBCH block candidates corresponding to black blocks out of eight blocks included in the set 7000. In FIG. 7, the first information indicates that the SS/PBCH blocks are not transmitted in resources corresponding to the SS/PBCH block candidates corresponding to white blocks out of the eight blocks included in the set 7000. For example, the first information may be provided by an RRC parameter. For example, the first information may be provided by an RRC parameter related to the BWP 6100. For example, the first information may be provided by an RRC parameter used for configuration of the BWP 6100.

Second information may be provided for the set 7001. For example, the second information may provide a set of indexes of the SS/PBCH blocks to be transmitted in the set 7001. In FIG. 7, the second information indicates index 0, index 3, index 6, and index 7. In FIG. 7, the second information indicates that the SS/PBCH blocks are transmitted in resources corresponding to the SS/PBCH block candidates corresponding to black blocks out of eight blocks included in the set 7001. In FIG. 7, the second information indicates that the SS/PBCH blocks are not transmitted in resources corresponding to the SS/PBCH block candidates corresponding to white blocks out of the eight blocks included in the set 7001. For example, the second information may be provided by an RRC parameter different from the RRC parameter used for provision of the first information. For example, the second information may be provided by an RRC parameter related to the BWP 6101. For example, the second information may be provided by an RRC parameter used for configuration of the BWP 6101.

In FIG. 7, the set 7000 may be used for transmission of the cell-defining SS/PBCH block. The frequency band of the set 7000 is set to be included in the BWP 6100. The frequency band of the set 7000 is set not to be included in the band of the BWP 6101. Here, the frequency band of the set 7000 is defined as the frequency band of the SS/PBCH block candidates included in the set 7000. Here, “a certain frequency band is included in another frequency band” signifies that “1) the frequency position at the start of the certain frequency band is not lower than the frequency position at the start of such another frequency band and 2) the frequency position at the end of the certain frequency band is not higher than the frequency position at the end of such another frequency band”. “A certain frequency band is not included in another frequency band” signifies that “1) the frequency position at the start of the certain frequency band is lower than the frequency position at the start of such another frequency band or 2) the frequency position at the end of the certain frequency band is higher than the frequency position at the end of such another frequency band”.

In FIG. 7, the set 7001 may be used for transmission of the non-cell defining SS/PBCH block. The frequency band of the set 7001 is set to be included in the frequency band of the BWP 6101. Note that, in FIG. 7, the frequency band of the BWP 6101 is set to be included in the frequency band of the BWP 6100; however, the frequency band of the BWP 6101 may or may not be included in the frequency band of the BWP 6100.

In the configuration as illustrated in FIG. 7, the terminal apparatus 1 of the first type may monitor the non-cell defining SS/PBCH block without monitoring the cell-defining SS/PBCH block. For example, the terminal apparatus 1 of the first type may perform Radio Link Monitoring (RLM) of the cell 6000, based on monitoring of the non-cell defining SS/PBCH block. For example, the terminal apparatus 1 of the first type need not use the cell-defining SS/PBCH block for Radio Link Monitoring (RLM) of the cell 6000.

The terminal apparatus 1 of the first type refers to an SS/PBCH block index for determination of a Transmission configuration indicator state of the PDSCH. Here, for the terminal apparatus 1 of the first type, the SS/PBCH block index may correspond to the non-cell defining SS/PBCH block.

On the other hand, in a case that transmission of an uplink channel to be scheduled by the terminal apparatus 1 of the first type collides with transmission of the cell-defining SS/PBCH block, it is preferable that the transmission of the uplink channel be suspended. This is because the transmission of the uplink channel may deteriorate quality of reception of the cell-defining SS/PBCH block by the terminal apparatus 1 of the second type.

In light of the above, the present application provides the terminal apparatus 1 including a preferable method of transmitting an uplink channel.

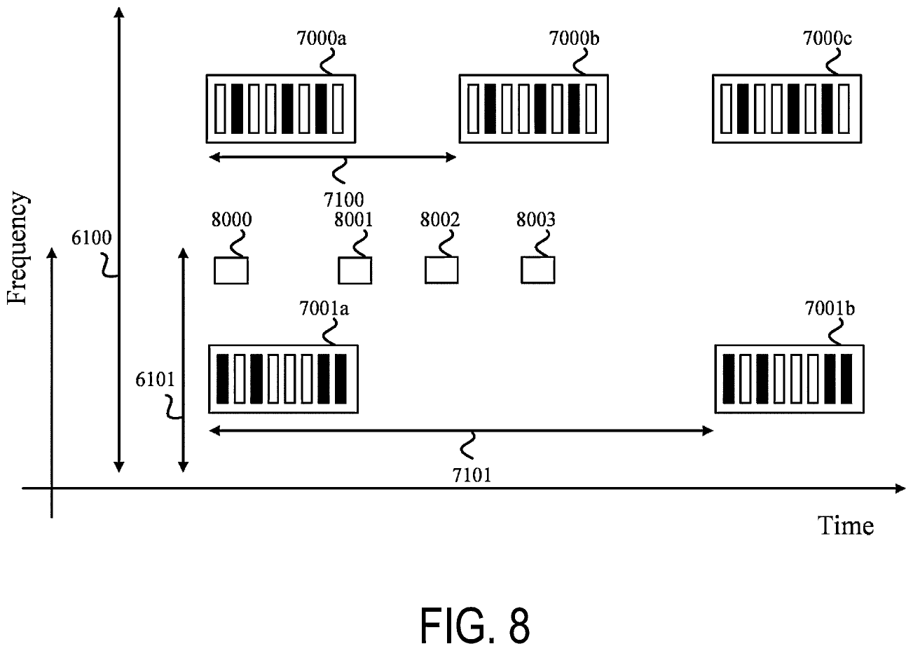

FIG. 8 is a diagram illustrating an example of transmission of uplink channels according to an aspect of the present embodiment. In FIG. 8, each of 8000, 8001, 8002, and 8003 is an uplink channel. Here, the uplink channel 8000 collides with transmission of the cell-defining SS/PBCH block of index 1 and transmission of the non-cell defining SS/PBCH block of index 0. In a case that the terminal apparatus 1 of the first type transmits the uplink channel 8000, the terminal apparatus 1 of the first type may drop transmission of the uplink channel 8000, based on collision of the uplink channel 8000 with transmission of the cell-defining SS/PBCH block or transmission of the non-cell defining SS/PBCH block. Here, collision of a certain channel and another channel signifies that at least one of a set of OFDM symbols constituting the certain channel and at least one of a set of OFDM symbols constituting such another channel are the same.

In FIG. 8, the uplink channel 8001 collides with transmission of the cell-defining SS/PBCH block of index 7. Here, in a case that the terminal apparatus 1 of the first type transmits the uplink channel 8001, the terminal apparatus 1 of the first type may drop transmission of the uplink channel 8001, based on collision of the uplink channel 8001 with transmission of the non-cell defining SS/PBCH block.

In FIG. 8, the uplink channel 8002 does not collide with transmission of any of the SS/PBCH blocks. Here, the terminal apparatus 1 of the first type may transmit the uplink channel 8002.

In FIG. 8, the uplink channel 8003 collides with transmission of the cell-defining SS/PBCH block of index 4. Here, the terminal apparatus 1 of the first type may drop transmission of the uplink channel 8003, based on collision of the uplink channel 8003 with transmission of the cell-defining SS/PBCH block.

In other words, the terminal apparatus 1 of the first type may determine whether or not to drop transmission of the uplink channel, based on the first information and the second information. For example, the terminal apparatus 1 of the first type may determine whether or not to drop transmission of the uplink channel, based on presence or absence of transmission of the cell-defining SS/PBCH block, which is provided by the first information, and presence or absence of transmission of the cell-defining SS/PBCH block, which is provided by the second information.

On the other hand, the terminal apparatus 1 of the second type may be further divided into two sub-types. The two sub-types are referred to as the terminal apparatus 1 of a second-A type and the terminal apparatus 1 of a second-B type.

For example, the terminal apparatus 1 of the second-A type may be the terminal apparatus 1 that does not recognize that the non-cell defining SS/PBCH block is transmitted in the cell 6000, and the terminal apparatus 1 of the second-B type may be the terminal apparatus 1 that recognizes that the non-cell defining SS/PBCH block is transmitted in the cell 6000.

For example, the terminal apparatus 1 of the second-A type may be the terminal apparatus 1 that does not recognize the second information, and the terminal apparatus 1 of the second-B type may be the terminal apparatus 1 that recognizes the second information.

For example, in a case that the terminal apparatus 1 of the second-A type transmits the uplink channel 8000, the terminal apparatus 1 of the second-A type may drop transmission of the uplink channel 8000, based on collision of the uplink channel 8000 with transmission of the cell-defining SS/PBCH block.

For example, in a case that the terminal apparatus 1 of the second-A type transmits the uplink channel 8001, the terminal apparatus 1 of the second-A type need not drop transmission of the uplink channel 8001, based on no collision of the uplink channel 8001 with transmission of the cell-defining SS/PBCH block.

For example, in a case that the terminal apparatus 1 of the second-A type transmits the uplink channel 8002, the terminal apparatus 1 of the second-A type need not drop transmission of the uplink channel 8002, based on no collision of the uplink channel 8002 with transmission of the cell-defining SS/PBCH block.

For example, in a case that the terminal apparatus 1 of the second-A type transmits the uplink channel 8003, the terminal apparatus 1 of the second-A type may drop transmission of the uplink channel 8003, based on collision of the uplink channel 8003 with transmission of the cell-defining SS/PBCH block.

In other words, the terminal apparatus 1 of the second-A type may determine whether or not to drop transmission of the uplink channel, based on the first information. For example, the terminal apparatus 1 of the second-A type may determine whether or not to drop transmission of the uplink channel, based on presence or absence of transmission of the cell-defining SS/PBCH block, which is provided by the first information. The terminal apparatus 1 of the second-A type need not recognize the second information.

For example, in a case that the terminal apparatus 1 of the second-B type transmits the uplink channel 8001, the terminal apparatus 1 of the second-B type may drop transmission of the uplink channel 8001, based on collision of the uplink channel 8001 with transmission of the non-cell defining SS/PBCH block.

For example, the terminal apparatus 1 of the second-B type may transmit the uplink channel 8002.

For example, the terminal apparatus 1 of the second-B type may drop transmission of the uplink channel 8003, based on collision of the uplink channel 8003 with transmission of the cell-defining SS/PBCH block.

In other words, the terminal apparatus 1 of the second-B type may determine whether or not to drop transmission of the uplink channel, based on the first information and the second information. For example, the terminal apparatus 1 of the second-B type may determine whether or not to drop transmission of the uplink channel, based on presence or absence of transmission of the cell-defining SS/PBCH block, which is provided by the first information, and presence or absence of transmission of the cell-defining SS/PBCH block, which is provided by the second information.

For example, “transmission of the uplink channel is dropped” may signify that “transmission is not performed regardless of the transmission of the uplink channel being scheduled”. For example, “transmission of the uplink channel is dropped” may signify that “a transmission occasion for the uplink channel is not determined”. For example, “transmission of the uplink channel is dropped in a certain slot” may signify that “the certain slot is not counted for the transmission of the uplink channel”. For example, “transmission of the uplink channel is dropped in a certain slot” may signify that “the certain slot is not determined as a slot for the transmission of the uplink channel”.

Here, “a certain BWP is referred to for the configuration in the terminal apparatus 1” may signify that “a part or all of the configurations of the antenna unit 11, the RF unit 12, and the baseband unit 13 in the terminal apparatus 1 are applied based on the frequency bandwidth of the certain BWP”. For example, “the configuration of the antenna unit 11 in the terminal apparatus 1 is applied based on the frequency bandwidth of a certain BWP” may signify that “the antenna unit 11 is configured to be capable of receiving a signal in the frequency bandwidth of the certain BWP”. For example, “the configuration of the RF unit 12 in the terminal apparatus 1 is applied based on the frequency bandwidth of a certain BWP” may signify that “the RF unit 12 is configured to be capable of receiving a signal in the frequency bandwidth of the certain BWP”. For example, “the configuration of the baseband unit 13 in the terminal apparatus 1 is applied based on the frequency bandwidth of a certain BWP” may signify that “the baseband unit 13 is configured to be capable of receiving a signal in the frequency bandwidth of the certain BWP”.

“A part or all of the configurations of the antenna unit 11, the RF unit 12, and the baseband unit 13 in the terminal apparatus 1 are applied based on a certain frequency band” may signify that “one or both of a channel bandwidth and a transmission bandwidth configuration is determined based on the certain frequency band”.

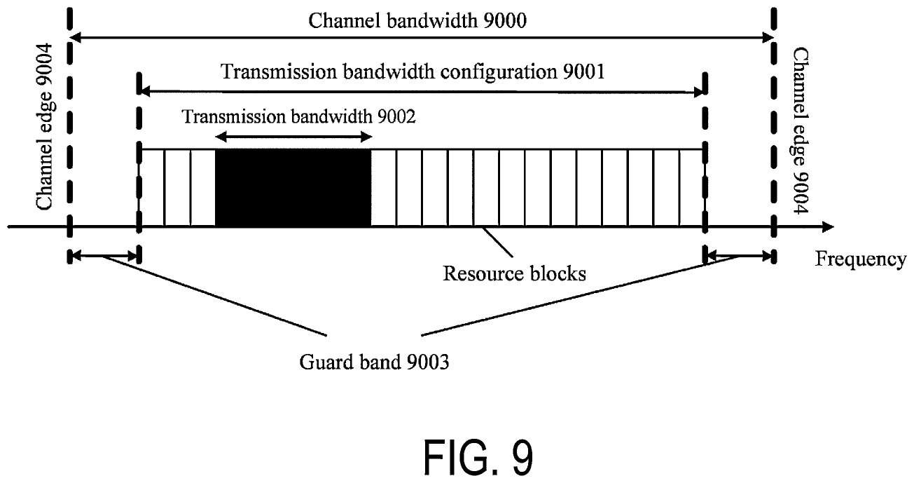

FIG. 9 is a diagram illustrating an example of a configuration of a carrier according to an aspect of the present embodiment. The horizontal axis in FIG. 9 indicates frequency. A channel bandwidth 9000 may be defined by contiguous frequency resources. The channel bandwidth 9000 may be frequency resources defined according to regulations (regurations) and the radio law of each country, and other reasons. A transmission bandwidth configuration (Transmissin bandwidth configuration) 9001 may include a subset of the frequency resources included in the channel bandwidth 9000. The transmission bandwidth configuration 9001 may include one or multiple resource blocks. Black blocks are also referred to as active resource blocks, and a band including the active resource blocks is referred to as a transmission bandwidth 9002. The frequency resources on the inside of the channel bandwidth 9000 and the outside of the transmission bandwidth configuration 9001 are referred to as a guard band 9003. Each edge of the channel bandwidth 9000 is referred to as a channel edge 9004.

The channel bandwidth 9000 may be an uplink channel bandwidth, or may be a downlink channel bandwidth. The transmission bandwidth configuration 9001 may be an uplink transmission bandwidth configuration, or may be a downlink transmission bandwidth configuration. The transmission bandwidth 9002 may be an uplink transmission bandwidth, or may be a downlink transmission bandwidth. The guard band 9003 may be an uplink guard band, or may be a downlink guard band. The channel edge 9004 may be an uplink channel edge, or may be a downlink channel edge.

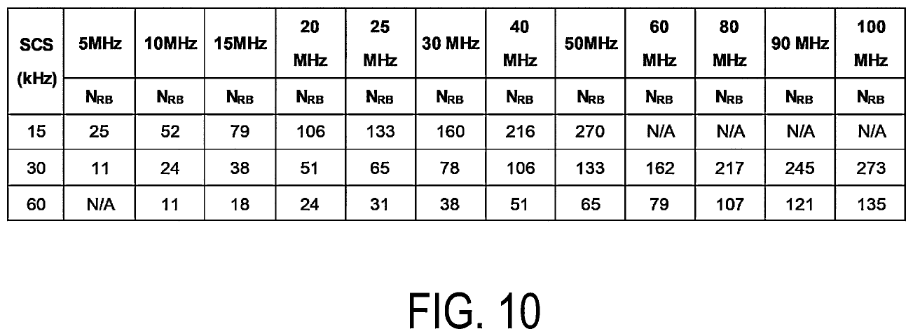

FIG. 10 is a diagram illustrating a configuration example of a maximum number N_{R}B of resource blocks of the transmission bandwidth configuration 9001 according to an aspect of the present embodiment. The topmost row of a table illustrated in FIG. 10 indicates the width of the frequency resources of the channel bandwidth 9000. In other words, for example, the width of the frequency resources of the channel bandwidth 9000 may be one of 5 MHz, 10 MHz, 15 MHz, 20 MHz, 25 MHz, 30 MHz, 40 MHz, 50 MHz, 60 MHz, 80 MHz, 90 MHz, and 100 MHz. The leftmost column of the table illustrated in FIG. 10 indicates the subcarrier spacing (unit: kHz). Each of elements not included in the topmost row of the table illustrated in FIG. 10 or not included in the leftmost column of the table indicates the maximum number N_{RB} of resource blocks of the transmission bandwidth configuration 9001. For example, the maximum number N_{RB} of resource blocks of the transmission bandwidth configuration 9001 in a case that the width of the frequency resources of the channel bandwidth 9000 is 5 MHz and the subcarrier spacing is 15 kHz may be 25. The maximum number N_{RB} of resource blocks of the transmission bandwidth configuration 9001 in a case that the width of the frequency resources of the channel bandwidth 9000 is 30 MHz and the subcarrier spacing is 30 kHz may be 78. The maximum number N_{RB} of resource blocks of the transmission bandwidth configuration 9001 in a case that the width of the frequency resources of the channel bandwidth 9000 is 5 MHz and the subcarrier spacing is 60 kHz may be N/A. N/A may indicate “undefined”. In other words, “the maximum number N_{RB} of resource blocks of the transmission bandwidth configuration 9001 corresponding to a set of the width of the frequency resources of a certain channel bandwidth 9000 and a value of a certain subcarrier spacing is N/A” may signify that “the set of the width of the frequency resources of the certain channel bandwidth 9000 and the value of the certain subcarrier spacing is undefined”.

The transmission bandwidth configuration 9001 may be at least used for configuring a requirement related to a part or all of out-of-band radiation, in-channel bandwidth reception sensitivity, and adjacent channel bandwidth reception sensitivity (Adjacent channel sensitivity). For example, a part or all of out-of-band radiation, in-channel bandwidth reception sensitivity, and adjacent channel bandwidth reception sensitivity may be given based at least on the number N of resource blocks of a certain transmission bandwidth configuration 9001. For example, the adjacent channel bandwidth reception sensitivity may be given for each set of the width of the frequency resources of a certain channel bandwidth 9000 and a transmit power value in the number N of resource blocks of a certain transmission bandwidth configuration 9001. A part or all of out-of-band radiation, in-channel bandwidth reception sensitivity, and adjacent channel bandwidth reception sensitivity may be given based at least on the maximum number N_{RB} of resource blocks of a certain transmission bandwidth configuration 9001. For example, the adjacent channel bandwidth reception sensitivity may be given for each set of the width of the frequency resources of a certain channel bandwidth 9000 and a transmit power value in the maximum number N_{RB} of resource blocks of a certain transmission bandwidth configuration 9001.

The transmission bandwidth 9002 may indicate a set of resource blocks in which a physical signal is transmitted. For example, the transmission bandwidth 9002 may correspond to a domain resource assignment of the PDSCH. The transmission bandwidth 9002 may correspond to a domain resource assignment of the PUSCH. The resource blocks included in the transmission bandwidth 9002 are also referred to as active resource blocks. The transmission bandwidth 9002 may be given based at least on a value of the domain resource assignment field included in the DCI format.

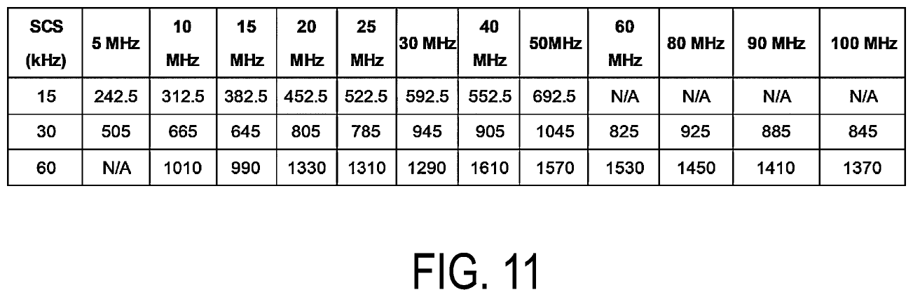

FIG. 11 is a diagram illustrating a configuration example of a minimum value of the guard band 9003 that can be configured for the channel bandwidth 9000 according to an aspect of the present embodiment. The topmost row of a table illustrated in FIG. 11 indicates the width of the frequency resources of the channel bandwidth 9000. The leftmost column of the table illustrated in FIG. 11 indicates the subcarrier spacing (unit: kHz). Each of elements not included in the topmost row of the table illustrated in FIG. 11 or not included in the leftmost column of the table indicates the minimum value (unit: kHz) of the guard band 9003 that can be configured for the channel bandwidth 9000. For example, the minimum value of the guard band 9003 in a case that the width of the frequency resources of the channel bandwidth 9000 is 5 MHz and the subcarrier spacing is 15 kHz may be 242.5 kHz. The minimum value of the guard band 9003 in a case that the width of the frequency resources of the channel bandwidth 9000 is 30 MHz and the subcarrier spacing is 30 kHz may be 945 kHz. The minimum value of the guard band 9003 in a case that the width of the frequency resources of the channel bandwidth 9000 is 5 MHz and the subcarrier spacing is 60 kHz may be N/A.

A relationship between the minimum value of the guard band 9003, the channel bandwidth 9000, and the subcarrier spacing illustrated in FIG. 11 may be given by: (CHBW-RBvalue*SCS*12)/2−SCS/2. Here, CHBW represents the width of the frequency resources of the channel bandwidth 9000, of which unit may be kHz. RBvalue may represent the number N of resource blocks of the transmission bandwidth configuration 9001 included in the channel bandwidth 9000. RBvalue may be the maximum number N_{RB} of resource blocks of the transmission bandwidth configuration 9001 included in the channel bandwidth 9000. RBvalue may correspond to one of the maximum numbers N_{RB} of resource blocks of the transmission bandwidth configuration 9001 in the table illustrated in FIG. 9. SCS represents the subcarrier spacing, of which unit may be kHz.

The band of the guard band 9003 given based on the transmission bandwidth configuration 9001 to be configured for the channel bandwidth 9000 may be configured not to fall below the minimum value of the guard band 9003.

Various aspects of apparatuses according to an aspect of the present embodiment will be described below.

(1) In order to accomplish the object described above, an aspect of the present invention is contrived to provide the following means. Specifically, a first aspect of the present invention is a terminal apparatus including: a physical layer processing unit configured to transmit a PUSCH; and an RRC layer processing unit configured to provide the physical layer processing unit with a first RRC parameter for a first SS/PBCH block mapped to a first frequency position in a serving cell and a second RRC parameter for a second SS/PBCH block mapped to a second frequency position in the serving cell. The physical layer processing unit determines whether or not to drop transmission of the PUSCH, based on the first RRC parameter and the second RRC parameter.

(2) In the first aspect of the present invention, a PBCH included in the first SS/PBCH block includes a MIB corresponding to the serving cell, and the PBCH included in the second SS/PBCH block does not include the MIB.

(3) In the first aspect of the present invention, a part of information bits included in a PBCH included in the first SS/PBCH block indicates a resource of a control resource set of index 0 in the serving cell, and none of the information bits included in the PBCH included in the second SS/PBCH block is used to indicate the resource of the control resource set.

(4) In the first aspect of the present invention, a SIB1 in the serving cell includes first information used for determining a first frequency band of a first initial BWP and second information used for determining a second frequency band of a second initial BWP. The first frequency position is a band from a first start frequency to a first end frequency. The second frequency position is a band from a second start frequency to a second end frequency. The first start frequency and the first end frequency are included in the first frequency band. The second start frequency and the second end frequency are included in the second frequency band. At least one of the first start frequency or the first end frequency is not included in the second frequency band.

(5) In the first aspect of the present invention, the physical layer processing unit monitors the second SS/PBCH block without monitoring the first SS/PBCH block.

(6) In the first aspect of the present invention, an n-th bit of the first RRC parameter indicates whether or not the first SS/PBCH block is transmitted in a resource corresponding to an SS/PBCH block candidate of index (n−1). An m-th bit of the second RRC parameter indicates whether or not the second SS/PBCH block is transmitted in the resource corresponding to the SS/PBCH block candidate of index (m−1).

(7) A second aspect of the present invention is a base station apparatus including: a physical layer processing unit configured to receive a PUSCH; and an RRC layer processing unit configured to provide the physical layer processing unit with a first RRC parameter for a first SS/PBCH block mapped to a first frequency position in a serving cell and a second RRC parameter for a second SS/PBCH block mapped to a second frequency position in the serving cell. The physical layer processing unit determines whether or not to drop reception of the PUSCH, based on the first RRC parameter and the second RRC parameter.

(8) In the second aspect of the present invention, a PBCH included in the first SS/PBCH block includes a MIB corresponding to the serving cell, and the PBCH included in the second SS/PBCH block does not include the MIB.

(9) In the second aspect of the present invention, a part of information bits included in a PBCH included in the first SS/PBCH block indicates a resource of a control resource set of index 0 in the serving cell, and none of the information bits included in the PBCH included in the second SS/PBCH block is used to indicate the resource of the control resource set.

(10) In the second aspect of the present invention, a SIB1 in the serving cell includes first information used for determining a first frequency band of a first initial BWP and second information used for determining a second frequency band of a second initial BWP. The first frequency position is a band from a first start frequency to a first end frequency. The second frequency position is a band from a second start frequency to a second end frequency. The first start frequency and the first end frequency are included in the first frequency band. The second start frequency and the second end frequency are included in the second frequency band. At least one of the first start frequency or the first end frequency is not included in the second frequency band.

(11) In the second aspect of the present invention, an n-th bit of the first RRC parameter indicates whether or not the first SS/PBCH block is transmitted in a resource corresponding to an SS/PBCH block candidate of index (n−1). An m-th bit of the second RRC parameter indicates whether or not the second SS/PBCH block is transmitted in the resource corresponding to the SS/PBCH block candidate of index (m−1).

A program running on the base station apparatus 3 and the terminal apparatus 1 according to an aspect of the present invention may be a program (a program that causes a computer to function) that controls a Central Processing Unit (CPU) and the like so as to implement the functions of the above-described embodiment according to an aspect of the present invention. The information handled in these apparatuses is temporarily loaded into a Random Access Memory (RAM) while being processed, is then stored in a Hard Disk Drive (HDD) and various types of Read Only Memory (ROM) such as a Flash ROM, and is read, modified, and written by the CPU, as necessary.

Note that the terminal apparatus 1 and the base station apparatus 3 according to the above-described embodiment may be partially implemented by a computer. In that case, this configuration may be implemented by recording a program for implementing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as peripheral devices. A “computer-readable recording medium” refers to a portable medium such as a flexible disk, a magneto-optical disk, a ROM, and a CD-ROM, and a storage apparatus such as a hard disk built into the computer system.

Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. The above-described program may be one for implementing a part of the above-described functions, and also may be one capable of implementing the above-described functions in combination with a program already recorded in a computer system.

Furthermore, the base station apparatus 3 according to the aforementioned embodiment may be implemented as an aggregation (apparatus group) including multiple apparatuses. Each of the apparatuses included in such an apparatus group may include a part or all of each function or each functional block of the base station apparatus 3 according to the aforementioned embodiment. As the apparatus group, it is only necessary to have all of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have a part or all of the functions of a higher node for an eNodeB and/or a gNB.

Also, a part or all portions of each of the terminal apparatus 1 and the base station apparatus 3 according to the aforementioned embodiment may be implemented as an LSI, which is typically an integrated circuit, or may be implemented as a chip set. The functional blocks of each of the terminal apparatus 1 and the base station apparatus 3 may be individually implemented as a chip, or a part or all of the functional blocks may be integrated into a chip. Furthermore, a circuit integration technique is not limited to the LSI and may be implemented with a dedicated circuit or a general-purpose processor. Moreover, in a case that a circuit integration technology that substitutes an LSI appears with the advance of the semiconductor technology, it is also possible to use an integrated circuit based on the technology.

In addition, although the aforementioned embodiments have described the terminal apparatus as an example of a communication apparatus, the present invention is not limited to such a terminal apparatus, and is also applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope that does not depart from the gist of the present invention. For an aspect of the present invention, various modifications are possible within the scope of the claims, and embodiments that are made by suitably combining technical means disclosed according to the different embodiments are also included in the technical scope of the present invention. In addition, a configuration in which elements described in the respective embodiments and having mutually similar effects are substituted for one another is also included.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1 (1A, 1B, 1C) Terminal apparatus
3 Base station apparatus
9 Radio communication system
10, 30 Physical layer processing unit
10a, 30a Radio transmitting unit
10b, 30b Radio receiving unit
11, 31 Antenna unit
12, 32 RF unit
13, 33 Baseband unit
14, 34 Higher layer processing unit
15, 35 Medium access control layer processing unit
16, 36 Radio resource control layer processing unit
6000 Cell
6001, 6002, 6003 Region
6010 Pattern
6100, 6101 BWP
7000, 7001 Set
7100, 7101 Period
8000, 8001, 8002, 8003 PUSCH
9000 Channel bandwidth
9001 Transmission bandwidth configuration
9002 Transmission bandwidth
9003 Guard band
9004 Channel edge

1-12. (canceled)

13: A terminal apparatus comprising:
reception circuitry configured to perform Radio Link Monitoring (RLM) of a cell based on monitoring of a non-cell defining SS/PBCH block, and
transmission circuitry configured to determine whether to drop transmission of an uplink channel based on collision of the uplink channel with the non-cell defining SS/PBCH block, wherein
the transmission circuitry is further configured to determine whether to drop the transmission of the uplink channel based on collision of the uplink channel with a cell defining SS/PBCH block, the cell defining SS/PBCH not being used for the RLM.

14: A base station apparatus comprising:
transmission circuitry configured to transmit a non-cell defining SS/PBCH block used for Radio Link Monitoring (RLM) of a cell, and
reception circuitry configured to determine whether to drop reception of an uplink channel based on collision of the uplink channel with the non-cell defining SS/PBCH block, wherein
the reception circuitry is further configured to determine whether to drop the reception of the uplink channel based on collision of the uplink channel with a cell defining SS/PBCH block, the cell defining SS/PBCH not being used for the RLM.

15: A communication method used for a terminal apparatus, the communication method comprising:
performing Radio Link Monitoring (RLM) of a cell based on monitoring of a non-cell defining SS/PBCH block,
determining whether to drop transmission of an uplink channel based on collision of the uplink channel with the non-cell defining SS/PBCH block, and
determining whether to drop the transmission of the uplink channel based on collision of the uplink channel with a cell defining SS/PBCH block, the cell defining SS/PBCH not being used for the RLM.
